(19) United States
(12) Patent Application Publication
(10) Pub. No.: US 2025/0165010 A1
(43) Pub. Date: May 22, 2025

(54) DISPLAY OF 3D ILLUMINATIONS USING FLYING LIGHT SPECKS

(71) Applicant: University of Southern California, Los Angeles, CA (US)

(72) Inventor: Shahram Ghandeharizadeh, Los Angeles, CA (US)

(21) Appl. No.: 18/867,970

(22) PCT Filed: May 26, 2023
(86) PCT No.: PCT/US2023/023757

§ 371 Date: Nov. 21, 2024

Related U.S. Application Data
(60) Provisional application No. 63/347,273, filed on May 31, 2022.

(51) Int. Cl. G05D 1/695; G05D 1/644; G05D 1/646; G05D 1/80; G05D 105/65; G05D 107/00; G05D 109/20

(52) U.S. Cl. CPC G05D 1/695; G05D 1/644; G05D 1/646; G05D 1/80; G05D 2105/65; G05D 2107/87; G05D 2109/20

(57) ABSTRACT

Present implementations can display 3D illuminations using Flying Light Specks (FLS). Each FLS can include a miniature (hundreds of micrometers) sized drone with one or more light sources to generate colors and textures with adjustable brightness. The FLS can be network enabled with a processor and local storage. Synchronized swarms of cooperating FLSs can render static and motion illumination of virtual objects in a pre-specified 3D volume, an FLS display. Present implementations can consider the limited flight time of an FLS on a fully charged battery and the duration of time to charge the FLS battery. Present implementations can accommodate failure of FLS as a norm of operation, rather than an exception. A hardware and software architectures for an FLS-display can compute flight paths of FLSs for illumination. With motion illuminations, one technique can minimize overall distance traveled by the FLSs significantly.

### TECHNICAL FIELD

The present implementations relate generally to systems, devices and methods that include or use autonomous drones to display 3D illuminations and, in particular examples, to such systems, devices and methods that include or use very small, flying drones or flying light specks (FLSs).

### BACKGROUND

Demands on presenting visualizations are increasing with respect to presentations environments and desired detail of such presentations. In particular, there is increasing demand for high-resolution visualization in 3D spaces independent of a screen or physical projection surface.

### SUMMARY

This technical solution is directed to managing and controlling FLSs (also termed FLS devices) to generate one or more two-dimensional or three-dimensional images. With a large number of FLS devices making up an image, an expected time to failure of the FLS devices begins to affect a fidelity of the image. At any point in time, one or more FLS devices may fail, affecting the image. By monitoring statuses of the FLS devices and accounting for changes in status, such as a failure, image fidelity can be maintained despite the failure of one or FLS devices. However, determining flight paths between locations in a volume without maintaining relative positions of FLS devices within the volume provides for elasticity in generating images and maintaining images despite FLS devices failures. Furthermore, by separating the FLS devices into one or more groups, portions of the image and/or imaging volume can be managed separately, increasing a reliability of the image and an efficiency of the imaging. For example, replacement FLS devices can be directed to replace failed FLS devices based on group associations, ensuring that failed FLS devices are replaced quickly and/or with replacement FLS devices that are closer than other replacement FLS devices.

Aspects of the present disclosure are directed to a method of controlling one or more flying speck (FLS) devices. The method can include providing at least one FLS system having a plurality of FLS devices at a first location relative to a volume space having a plurality of cells. The method can include dispensing at least one of the FLS devices from the FLS system to at least one of the plurality of cells within the volume space. The method can include selecting, based on a change in operating state of the at least one dispensed FLS device, at least one of the dispensed FLS devices. The method can include retrieving at least one of the selected FLS device from the volume space and delivering the retrieved FLS device to the FLS system.

Aspects of the present disclosure are directed to a system for controlling one or more flying light speck (FLS) devices. The system can include an FLS system having a plurality of FLS devices at a first location relative to a volume space defined in a projection volume, the projection volume divided into a plurality of cells. The system can include a dispatcher to selectively dispense at least one of the FLS devices from the FLS system to at least one of the plurality of cells within the volume space. The system can include a garbage collector to retrieve at least one further FLS device from the volume space and deliver the retrieved FLS device to the FLS system upon an indication of failure of the at least one further FLS device.

Aspects of the present disclosure are directed to a method of controlling one or more flying light speck (FLS) devices. The method can include dispatching an FLS device from a hangar along a path within a predetermined volume. The method can include receiving the FLS device at a charging station adjacent to the predetermined volume in response to a power level of the FLS device satisfying a first power threshold. The method can include receiving the FLS device at a garbage collector adjacent to the predetermined volume in response to a state of the FLS device indicating a failure of the FLS device.

Aspects of the present disclosure are directed to a method including determining a first arrangement of a plurality of flying light specks (FLSs), the first arrangement corresponding to a first three-dimensional (3D) image. The method can include determining a second arrangement of the plurality of FLSs, the second arrangement corresponding to a second three-dimensional (3D) image. The method can include determining a plurality of paths through a 3D volume between the first arrangement and the second arrangement. The method can include transmitting the plurality of paths to the plurality of FLSs to cause the plurality of FLSs to transition from the first arrangement corresponding to the first 3D image to the second arrangement corresponding to the second 3D image.

Aspects of the present disclosure are directed to a system including a first dispatcher configured to dispatch a first set of flying light specks (FLSs) and a second dispatcher configured to dispatch a second set of FLSs. The system can include a controller configured to determine an arrangement of FLSs, transmit a first signal to the first dispatcher to dispatch a first subset of the first set of FLSs to the arrangement, and transmit a second signal to the second dispatcher to dispatch a second subset of the second set of FLSs to the arrangement.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1A illustrates a system to display 3D illuminations using FLS.

FIG. 1B illustrates an example illumination.

FIG. 2 illustrates a computer architecture to display 3D illuminations using FLS.

FIG. 3 illustrates a process to display 3D illuminations using FLS.

FIG. 4 illustrates a performance of flight distance as a function of point cloud size based on a number of FLS.

FIG. 5 illustrates a performance of execution time in view of point cloud size based on a number of FLS.

FIG. 6 illustrates a performance of flight distance in view of point cloud size based on a size of cuboids.

FIG. 7 illustrates a performance of execution time in view of point cloud size based on a size of cuboids.

FIG. 8 illustrates an example method for managing changes in operating state of FLSs.

FIG. 9 illustrates an example method for managing battery charge levels and failures of FLS devices.

FIG. 10 illustrates an example method for transitioning from a first arrangement to a second arrangement.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

This technical solution can include managing the FLS devices over their lifecycle. The FLS devices may have a predetermined battery life and an expected time to failure. An FLS device can be dispensed to a volume space to be part of an image rendered using multiple FLS devices. The FLS device can be retrieved from the volume space based on a change in status, such as low battery, malfunction, or expected malfunction. Another FLS device can be dispensed to replace the FLS device in the volume space. By dispensing and retrieving the FLS devices based on their battery life and/or expected time to failure, an image quality of an image rendered using the FLS devices can be improved. By managing the FLS devices based on characteristics such as battery life and expected time to failure, a large number of FLS devices can be used despite the statistical certainty of FLS device failures. Active management of the FLS devices mitigates the inevitable FLS device failures such that images can be rendered using a large number of FLS devices, including thousands, tens of thousands, and hundreds of thousands of FLS devices.

Images can be rendered and animated using the FLS devices by dispatching FLS devices based on an image to be rendered and a next image to be rendered. By rendering a series of images in succession, the FLS devices can be used to render an animation. The FLS devices can render successive images in an animation by occupying a first arrangement corresponding to an image and then flying along predetermined paths to occupy a second arrangement corresponding to a successive image. In an example, the predetermined flight paths are determined to minimize flight time of the FLS devices to transition from the first arrangement to the second arrangement to speed up the animation. FLS devices can be dispensed from dispatchers located adjacent the volume space based on how many FLS devices are needed to render the images of the animation, how many FLS devices have failed, and how many FLS devices are expected to fail. In some embodiments, the predetermined flight paths are determined to adjust the images of the animation to prioritize portions of the images that are more noticeable to an observer or which or more visible. In an example, the predetermined flight paths are determined to minimize a flight time of a subset of the FLS devices based on the subset of the FLS devices being more visible to a viewer than another subset of the FLS devices.

Example implementations of the present disclosure can display 3D illuminations using flying, autonomous drones. In particular examples, each drone is a Flying Light Specks (FLS), a miniature (hundreds of micrometers) sized drone with one or more light sources to generate colors and textures with adjustable brightness. The FLS can be network enabled with a processor, communication interface, and local storage. In some embodiments, a first subset of FLSs include local storage while a second subset of FLSs do not include local storage. The first subset of FLSs can communicate with the second subset of FLSs to provide storage for the second subset of FLSs. In an example, groups of FLSs each include a storage FLS having local storage which provides storage for the group. Synchronized swarms of cooperating FLSs can render static and motion illumination of virtual objects in a pre-specified 3D volume, an FLS display. In some examples, the pre-specified 3D volume (and the FLS display) may be relatively small, such as a size that could be disposed on a table top, a desk top, a surface of a floor in a room, or the like. In other examples, the 3D volume (and the FLS display) may be larger than those examples. While examples are described herein, in the context of FLSs that form FLS displays, various aspects of the devices, systems and methods described herein may include or be employed with automated drone devices that are larger than FLSs for implementing a visual 3D illuminated display that may be larger than an FLS display.

The FLS can include one or more sensors. The one or more sensors can allow the FLS to localize its position within a volume space and/or relative to other FLSs. The FLS can include a clock, such as a digital clock running on the processor of the FLS. The FLS can receive a message for setting the clock. The message can be transmitted to synchronize clocks of a plurality of FLSs with a predetermined error. In some embodiments, an accuracy of localization of each FLS is based on the predetermined error of synchronization.

Present implementations can consider the limited flight time of an FLS on a fully charged battery and the duration of time to charge the FLS battery. Present implementations can accommodate failure of FLS as a norm of operation, rather than an exception. A hardware and software architectures for an FLS-display can compute flight paths of FLSs for illumination. With motion illuminations, one technique can minimize overall distance traveled by the FLSs significantly.

A Flying Light Speck, FLS, can include a miniature sized unmanned or unpiloted autonomous vehicle (UAV) configured with Red, Green, and Blue light sources to render illuminations. It can be battery powered, network enabled, with some storage, and processing capability to implement decentralized processes. For example, an FLS can have a volume or size corresponding to hundreds of micrometers. For example, an FLS can have a size on the order of centimeters, millimeters, or micrometers.

A swarm of cooperating FLSs can be synchronized to render an illumination of a virtual object in a 3D FLS display. The display can include a volume partitioned into a mesh of 3D cells. Each cell of the display can be identified by its length, height, and depth (L, H, D) coordinates. The L, H, D coordinate system can be used instead of the X, Y, Z because there can be conflict between definitions of these axes. L, H, D can be mapped to any definition under an X, Y Z coordinate space.

In some aspects, a method of controlling one or more flying light speck (FLS) devices includes dispatching an FLS device from a hangar along a path within a predetermined volume, receiving the FLS device at a charging station adjacent to the predetermined volume, in response to a power level of the FLS device satisfying a first power threshold, and receiving the FLS device at a garbage collector adjacent to the predetermined volume, in response to a state of the FLS device indicating a failure of the FLS device.

In some aspects, the method includes dispatching the FLS device from the charging station into the predetermined volume, in response to the power level of the FLS device satisfying a second power threshold.

In some aspects, the method includes dispatching a second FLS device from the hangar into the predetermined volume, in response to the state of the FLS device indicating the failure of the FLS device.

In some aspects, the example system includes a plurality of FLS devices.

In some aspects, the example system includes at least one thousand FLS devices.

In some aspects, the predetermined volume includes a plurality of cells.

The size of a display cell can be based on an FLS downwash, a region of instability caused by the flight of one unmanned aerial vehicle (UAV) or FLS that adversely impacts other UAVs entering this region, e.g., loss of control or unpredictable behavior. FLSs may be UAVs. Light emitted by an FLS can be greater than a display cell, positioning the FLS at the center of multiple cells along each dimension.

A static illumination can include a point cloud. Each point pi identifies a 3D coordinate with a value for its color model. The RGBA model can specify the red, green, blue, and alpha color settings. Hence, a point can include a {lᵢ, hᵢ, dᵢ, Rᵢ, Gᵢ, Bᵢ, Aᵢ}.

A motion illumination can include a stream. It may be a stream of {pᵢ, lᵢ, hᵢ, dᵢ, Rᵢ, Gᵢ, Bᵢ, Sᵢ, eᵢ} where pᵢ can include a unique identifier and sᵢ, eᵢ specify an interval relative to the start of an illumination to display the point identified by pᵢ. Alternatively, it may be a stream of point clouds that can be rendered at a pre-specified rate, e.g., 24 point clouds per second. Yet another possibility can include a hybrid of these two by associating only one {s, e} for a point cloud and individual {sᵢ, e_{i}}for select points. A second representation, i.e., a sequence of point clouds, can be rendered at a pre-specified rate.

Display of a motion illumination can be continuous when FLSs render its point cloud in a timely manner. Each point cloud has a start and an end time stamp relative to the start of the illumination. FLSs rendering a point cloud Ξᵢ at time Tⱼ may fly to positions determined by the next point cloud Ξᵢ₊₁ at time T_{j+δ}. δ can include dictated by the rate of point clouds displayed per unit of time, e.g.,

$$Δ = \frac{1}{24}$$

seconds when 24 point clouds are rendered per second. Once at their new position, FLSs can render the lighting required by the point cloud Ξᵢ₊₁. This process can continue until all point clouds of a motion illumination are displayed.

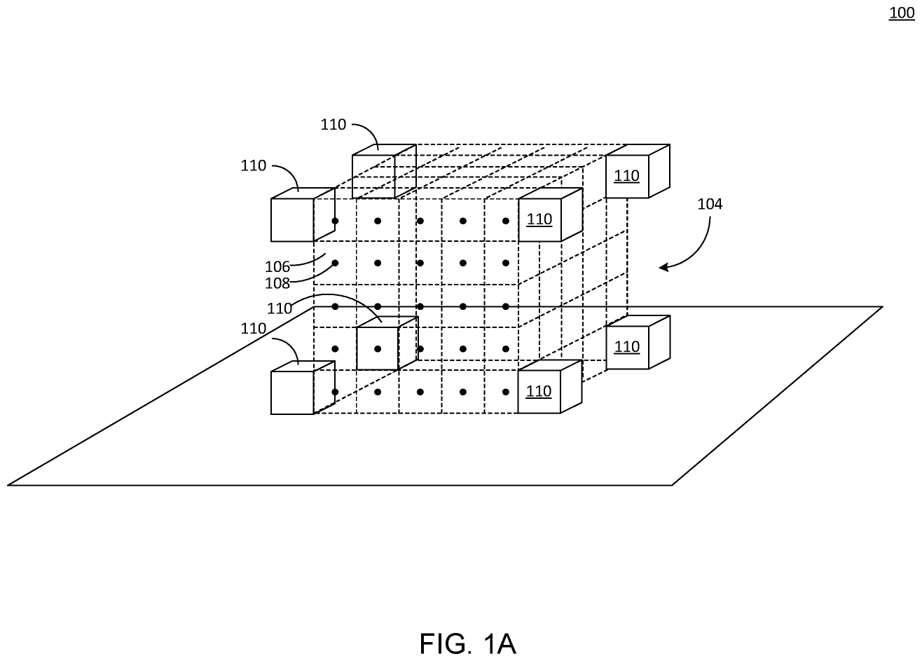

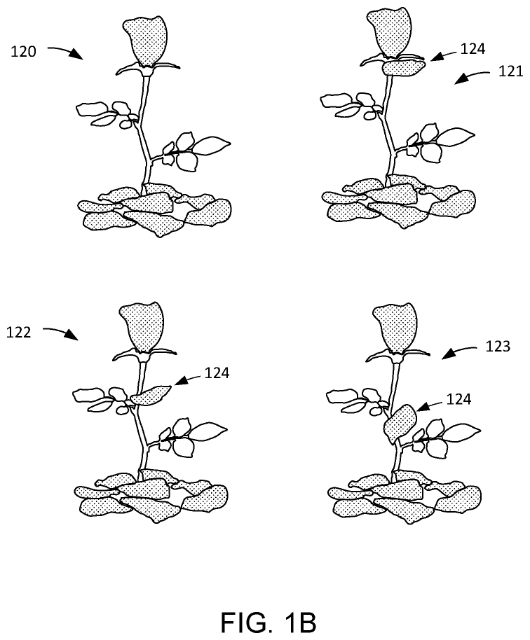

Display of both static and motion illuminations can be non-trivial for several reasons. First, a rendering may include a large number of FLSs. For example, each point cloud of the Rose illumination of FIG. 1B can include 65K points (FLSs). More complex illuminations can include millions, billions, and potentially trillions of points. Second, FLSs are mechanical devices that can fail. Hence, failures are the norm rather than an exception. Techniques to render an illumination using constantly failing FLSs are needed. Third, each FLS is battery-powered with a fixed flight time. The battery of each FLS requires a certain amount of time to charge. A key consideration is the relationship between these factors and the extra number of FLSs for rendering an illumination.

Fourth, flight of FLSs may result in collisions. Computing collision free paths is expensive with tens of UAVs. This may be prohibitively expensive with tens of thousands of FLSs. It may be impractical in the presence of FLSs with limited flight times failing constantly. Present implementations can detect FLS conflicts when computing flight paths. The system can provide this information to the FLSs that participate in the conflict. When FLSs take flight to render an illumination, they can use this information to implement a decentralized technique to avoid collisions. For example, the FLSs that participate in a collision can take turns flying to their destination by using their unique identifier to order themselves. Such decentralized techniques can be implemented using the networking, processing, and storage capabilities of FLSs.

Present implementations can include architecture for FLS displays to render 3D illuminations, both static and motion illuminations. MinDist and QuotaBalanced processes can render a static illumination as discussed herein. These may be used in either offline or online mode. In offline mode, they compute a representation that may be stored in a file for future use without re-running the process. In online mode, they render the illumination without generating files. Both processes are fast and run in tens of milliseconds with illuminations consisting of tens of thousands of points.

Motill can include a family of offline processes to compute flight paths of FLSs that render different point clouds of a motion illumination. One technique, ICF, minimizes the overall distance travelled by FLSs when compared with the other alternatives. Its execution time may be faster than execution times of other techniques, as discussed herein. A technique that uses standby FLSs to render an illumination in the presence of FLS failures. As an example, with a mean time to failure of an FLS of once a month, a quality of the Rose illumination of FIG. 1B may degrade once every 40 seconds due to failures. Present implementations may enhance this mean time to failure to once a month or more depending on the incurred overhead in the form of additional FLSs.

Staggered Battery Charging (STAG) can include a technique that overlaps charging of some FLS batteries with other FLSs that render an illumination. STAG may minimize the total number of FLSs and charging stations for an illumination.

. FIG. 1A illustrates a display system to display 3D illuminations using one or more (or a plurality of) FLS systems. As illustrated by way of example in FIG. 1, an example display system 100 can include a physical projection reference 102, a predetermined projection volume 104 including one or more (or a plurality of) cells 106, and one or more (or a plurality of) FLS systems 110. The physical projection reference 102 can include a floor, ground, a table top, wall, ceiling, roof, or any combination thereof.

The predetermined projection volume 104 may be divided into one or more cells 106 (a mesh of cells). In the example in FIG. 1, the predetermined projection volume 104 is represented by a cube in a volume space on top of the physical projection reference 102. In the example in FIG. 1, the volume 104 includes a plurality of cube-shaped cells 106. A respective FLS system 110 may be located at each respective corner of the cube-shaped volume 104. In other examples, the predetermined projection volume 104 and the cells 106 may have other shapes including, but not limited to cuboid, rectangular prism, cylindrical, spherical, ovoid, any regular or irregular three-dimensional polygon, or combinations thereof. During the display of an illumination, one or more (or each) cell 106 is occupied by at least one FLS 108. The FLS 108 can be assigned to a particular cell 106, or can be associated with one or more cells 106 in connection with a flight path of the FLS 108. The cells can be defined by a logical relationship between FLS devices. In an example, the FLS occupies a cell 106 where the bounds of the cell 106 are based on a downwash of the FLS 108 and/or a turbulence zone of the FLS 108. The cells 106 can be defined by set boundaries set relative to the FLS systems 110, the physical projection reference 102, and/or the predetermined projection volume 104.

To display an illumination, an Orchestrator can construct, virtually, a 3D mesh of cells in the display volume, such as represented by the 3D arrangement of cells in FIG. 1. A cell of this mesh can be defined by the downwash of an FLS. An FLS can include a quadrotor, and a cell may be an ellipsoid or a cylinders that results in a larger separation along the height dimension. Each display cell has a unique (L,H,D) coordinate. The display cell may be referenced by one point in the point cloud. A display cell can be occupied by one FLS. Its size can be defined by the downwash of the FLS. The display cell may be identified by a unique (L,H,D) coordinate. The FLS system 100 can coordinate the movement, deployment, routing, and collection of devices larger than an FLS device. The FLS system 100 can coordinate the movement, deployment, routing, and collection of any collection of drone devices having a number of drones sufficiently high to achieve the resolution of the FLS display, and can accommodate loss of devices, including drone devices, of any size employed in the use of an FLS display.

A cuboid can represent an illumination cell rendered by an FLS light source. The size of this cuboid can be defined by the characteristics of the FLS light source. It may be either smaller than, equal to, or larger than a display cell. When it is smaller, an FLS may be configured with multiple sets of RGB light sources to render different points. When equal to or greater than, an FLS may be configured with one set of RGB light sources. When greater than, the FLS's light sources illuminate a point that corresponds to multiple display cells. Hence, the FLS may be placed at the center of these display cells for illumination. For example, an FLSᵢ can pass by FLSⱼ as long as it stays outside of FLSⱼ's display cell. In some embodiments, an FLs can include a reflective surface. In an example, the FLS includes a reflective surface for reflecting light but not a light source. In another example, the FLS includes a reflective surface and a light source.

A cuboid can include six flat faces and eight vertices. All cuboid faces are rectangles. A cuboid is a square prism when at least two faces are squares. A cuboid is a cube when all its six faces are squares. Each of those shapes may be referred to herein as a cuboid. An illumination cell is a cuboid that is larger than or equal to a display cell. An FLS may be positioned such that its rendered light fills the illumination cell. In some embodiments, the illumination cell may be occupied by one FLS. Depending on its size, two or more FLSs may occupy it with at most one illuminating its light. The other FLSs, not illuminating the illumination cell, may either be a standby for failure handling or transitory on their route to their assigned coordinates. A point in a point cloud identifies the display cell occupied by an FLS.

Certain example implementations can display static illumination. A process may illuminate a point cloud based on different objectives. An example objective is to minimize the total distance traveled by FLSs to arrive at the display coordinate of their assigned point, i.e., minimize Σᵢ₌₁^{ψ}Σᵢ₌₁^{k}^{ᵢ}, Distance (Dispatchᵢ, Pⱼ) where kᵢ is the number of points assigned to a number of points assigned to a dispatcher i and ψ is the number of dispatchers. MinDist is a process that may iterate each point, compute the distance of the point in the display mesh to a dispatcher, and assign the point to the dispatcher with the shortest Euclidean distance.

TABLE 1
Notations and their definitions.

| Notation | Definition |
|---|---|
| Ξi | Point cloud i. |
| Ψ | Number of dispatchers. |
| θ | Max number of points/FLSs assigned to a cuboid. |
| β | Flight time of an FLS on a fully charged battery. |
| Ω | Time to charge an FLS battery fully. |
| κᵢ | Number of points assigned to Dispatcher i. |
| α | Number of points/FLSs in a point cloud. |
| MTTF | Mean Time To Failure of an FLS. |

Subsequently, each dispatcher may sort its assigned points based on their distance from its location. Each dispatcher may deploy FLSs to render points starting with the farthest away point. This may minimize the possibility of dispatched FLSs colliding with one another. The first for loop of MinDist may be sequential and may be implemented by the Orchestrator. The second for loop may be processed by each dispatcher in parallel and independent of the Orchestrator. The complexity of the first loop is O(ψ×α) where α is the number of points in a point cloud and ψ is the number of dispatchers. The complexity of the second loop can be defined by the number of points κi assigned to a dispatcher i and its process to sort the points based on their distance, e.g., with the QuickSort process, the complexity is O (kᵢ²) for dispatcher i.

MinDist has several characteristics. First, MinDist may result in a slow rendering of an illumination by utilizing a subset of dispatchers more often than others. This happens when most of the points in a cloud are clustered in close proximity of a few dispatchers. While these dispatchers deploy most of the FLSs sequentially, other dispatchers may sit idle. Second, MinDist assumes a dispatcher has access to all hangars and their FLSs. This assumption is violated when hangars are physically partitioned across dispatchers. When an illumination consists of a cluster of points in close proximity of a dispatcher with insufficient number of FLSs then, MinDist may not render the illumination.

FIG. 1B illustrates an example illumination. The example illumination may include a rose and may be termed the “Rose illumination.” The Rose illumination may include a first point cloud 120, a second point cloud 121, a third point cloud 122, and a fourth point cloud 123. The Rose illumination may include a plurality of point clouds. The plurality of point clouds may animate an image. In an example, the Rose illumination includes 115 point clouds rendered at 24 point clouds per second with a 4.79 second display time. In this example, the first point cloud 120 may be a first point clouds of the plurality of point clouds, the second point cloud 121 may be a 38^{th} point clouds of the plurality of point clouds, the third point cloud 122 may be a 58^{th} point cloud of the plurality of point clouds and the fourth point cloud 123 may be a 79^{th} point cloud of the plurality of point clouds.

Each point cloud of the Rose illumination may be a 3D image. Each point cloud of the Rose illumination may be a frame of an animation. In an example, the Rose illumination may be an animation of a 3D rose with a petal 124 falling to the ground. Each point cloud may be rendered by FLSs. In an example, each point cloud of the Rose illumination may be rendered by 65,000 FLSs. Some illuminations may use different numbers of FLSs in different point clouds, requiring FLSs to be added or subtracted from the rendering of the illumination, as discussed herein. Point clouds may include any number of FLSs, including millions, or billions of FLSs.

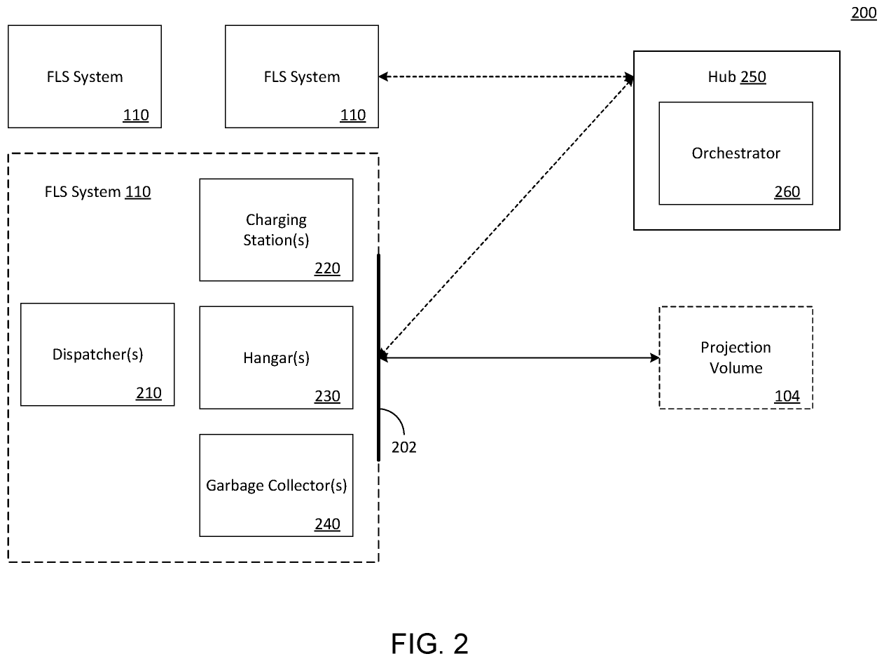

FIG. 2 illustrates a computer architecture to display 3D illuminations using FLS. As illustrated by way of example in FIG. 2, an example architecture 200 can include the one or more of the FLS system 110, the projection volume 104, and the hub 250.

The FLS system 100 can include at least one terminus 202, at least one dispatcher 210, at least one charging station 220, at least one hangar 230, and at least one garbage collector 240. The terminus 202 has one or more entry points in the display associated with the projection volume. The terminus 202 can include a region of the projection volume 104 or a region of the FLS system 110 designated for an FLS to position itself in the event of malfunction or battery depletion, for example. The terminus 202 can form a physical space adjacent to or proximate to both of the FLS system 110 and the projection volume 104.

The dispatcher 210 can deploy one or more FLSs to render an illumination The dispatcher 210 can include an FLS status transceiver and a deployment scheduler. The FLS status transceiver can communicate status of one or more FLSs to one or more others FLSs of the system. The deployment scheduler can coordinate movement of ore or more FLSs in one or more cells.

The charging station 220 can charge the battery of one or more FLSs and can deposit those FLSs with fully charged batteries to the hangar 230. A charging station has one or more well defined entry points known to the FLSs. The charging station 220 can include an entry point transceiver and a hangar control bridge. The entry point transceiver can communicate the presence or location of an entry point for an FLS that is located at a particular charging station. The hangar control bridge can communicate with one or more FLSs can manage control or communication handoff between the charging stations and the hangars.

The hangar 230 can protect one or more FLSs from external factors that may either damage them or reduce their lifetime. A hangar may be accessible to one or more dispatchers 210, charging stations 220, and terminus 202 areas. The garbage collector 240 can collect one or more failed FLSs that fall to the bottom of the display and can bring them to the terminus 202. The garbage collector 240 may be in the form of a conveyor belt that moves failed FLSs away from the display grid and into entry points that open to the terminus 202. In some embodiments, the garbage collector 240 collects the failed FLSs by the failed FLSs flying to the garbage collector 240 and/or landing on the garbage collector 240.

The hub can communicate with one or more of the FLS systems 110 or one or more of the components thereof. The hub can include an orchestrator 260. As discussed herein, the orchestrator 260 can construct, virtually, a 3D mesh of cells in the projection volume 104. The orchestrator 260 can include an operating system. The operating system can include hardware control instructions and program execution instructions. The operating system can include a high level operating system, a server operating system, an embedded operating system, or a boot loader. The operating system can include one or more instructions operable specifically with or only with a system processor.

The FLS dispatch controller 220 can correspond at least partially in one or more of structure and operation to the dispatchers as discussed herein. The FLS dispatch controller 220 can include an FLS status transceiver 222 and a deployment scheduler 224. The FLS status transceiver 222 can communication status of one or more FLSs to one or more others FLSs of the system. The deployment scheduler 224 can coordinate movement of ore or more FLSs in one or more cells.

The garbage collection controller 250 can correspond at least partially in one or more of structure and operation to the garbage collectors as discussed herein. The garbage collection controller 250 can include an FLS loss monitor 252 and a terminus processor 254.

The FLS loss monitor 252 can track the failure of FLSs in the system and can provide request to replenish a supply of FLSs to replace the loss. The terminus processor 254 correspond at least partially in one or more of structure and operation to the terminus areas as discussed herein, and can communicate the presence or location of an entry point in the display cell or cells.

Thus, the 3D FLS display can include a number of software and hardware components, including hangars, charging stations, dispatchers, garbage collectors (GCs), terminus areas, an orchestrator, and a hub. FLSs may be kept in one or more hangars. Hangars protect FLSs from external factors that may either damage them or reduce their lifetime. A hangar may be accessible to one or more Dispatchers, Charging Stations, and Terminus. Charging Stations charge the battery of FLSs, depositing those with a fully charged battery to a hangar. A charging station has one or more well defined entry points known to the FLSs. The charging station may be an electromagnetic charger. The FLSs may be charged by the electromagnetic charger when the FLSs are within a range of the electromagnetic charger. The charging station may be a wireless charger.

One or more dispatchers deploy FLSs to render an illumination. One or more hangars may be accessible to a dispatcher. Dispatchers may communicate identity, flight path, and deploy time of their FLSs to one another to detect potential FLS crashes. Each dispatcher has a unique id. This id may be used to implement a decentralized process to avoid potential crashes. One or more GCs collect failed FLSs that fall to the bottom of the display and bring them to a Terminus. A GC may be in the form of a conveyor belt that moves failed FLSs away from the display grid and into entry points that open to the Terminus. A Terminus has one or more entry points in the display. In addition to GCs, an FLS that detects it may no longer function properly may fly to a Terminus. A Terminus may diagnose a failed FLS, perform procedures to recover it to normal mode of operation, and deposit a recovered FLS to a hangar.

An Orchestrator can include a software component that manages FLSs in Hangars, Charging stations, Dispatchers, Garbage Collectors, and Terminus. It also manages the storage and network of the Hub. The Orchestrator may delegate tasks to other components. For example, it may delegate deployment of FLSs to one or more dispatchers. The Orchestrator implements centralized processes to render a motion illumination. It may also implement hybrid centralized and decentralized processes that include the participation of the FLSs. For example, with the parity-based technique, the Orchestrator may identify the number of FLSs in a group and their identity. However, detection of FLS failures and subsequent substitution of a parity FLS for the failed FLS may be performed by the FLSs without the Orchestrator involvement. At the other end of the spectrum, certain tasks may be implemented in a decentralized manner independent of the Orchestrator. An example is collision avoidance implemented by FLSs. A Hub provides the processing, storage, and networking capabilities of an FLS display. It uses an off-the-shelf operating system such as the Linux Ubuntu. The Hub executes the Orchestrator software that manages and coordinates all aforementioned components.

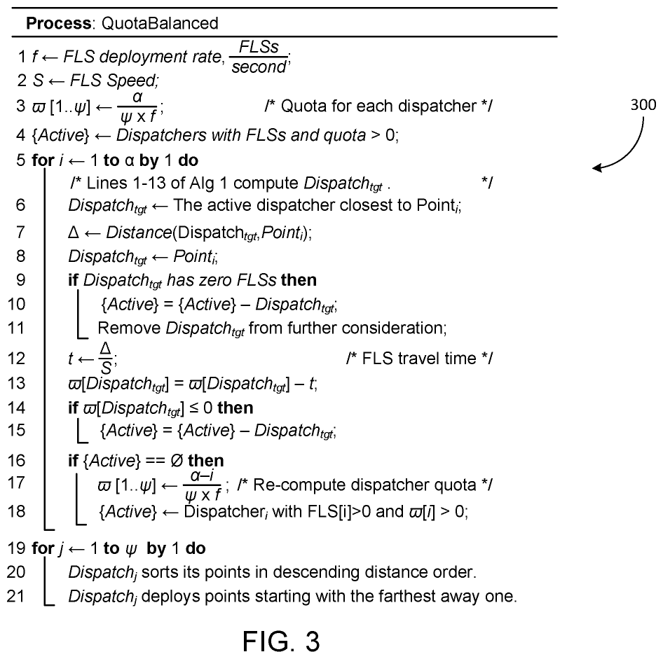

FIG. 3 illustrates a process to display of 3D illuminations using FLS.

A process, QuotaBalanced, considers the distance travelled by FLSs, FLS speed, the number of dispatchers, the number of FLSs accessible to a dispatcher, and the rate at which a dispatcher may deploy FLSs. It assigns a quota to each dispatcher that may be reduced as a function of the traveled time by its deployed FLSs. The idea is to have a dispatcher that is very far from the points of a cloud to deploy some FLSs but not as many FLSs as those dispatchers that are in close proximity to the points of the cloud.

Distance may be used as an approximation of time. The time for an FLS to fly from a dispatcher to its display cell is a more precise approximation. It considers the speed of FLSs. A dispatcher may be far from the point cloud. However, if FLSs are extremely fast then the time to deploy FLSs may become dominant, motivating the use of this dispatcher to deploy its fair share of FLSs. QuotaBalanced implements this tradeoff.

QuotaBalanced assumes each dispatcher may deploy f FLSs per time unit (Line 1 of Proc. 2) and dispatcher i has access to a fixed number of FLSs. The granularity of its quota is time units required for a dispatcher to deploy its fair share of FLSs for the point cloud,

$$\frac{a}{ψ \times f} .$$

This process converts distance to time using the speed of an FLS, as shown in Line 13 of FIG. 3. In each iteration, QuotaBalanced reduces the quota of a dispatcher by the FLS travel time to its assigned point and its display cell. Once the quota of a dispatcher is exhausted, it may be removed from the list of active dispatchers. This causes QuotaBalanced to assign points to other dispatchers that may not be necessarily as close. However, the quota of these dispatchers may be reduced by a larger value because they are farther away, i.e., time to travel is longer. Hence, these dispatchers may be removed from the active list after a fewer point assignments.

The quota of dispatchers may be exhausted with unassigned points remaining. QuotaBalanced re-computes the quota of each dispatcher using the remaining points, as shown in Lines 18-21. It continues to assign points to the dispatchers until their quotas are exhausted. Point may be assigned to the dispatchers until all points are. In an example, the quotas of the dispatcher may be re-computed 1,393 times for an example point cloud.

A dispatcher with no FLSs may be permanently removed from the Active list (Lines 9-12). This causes other dispatchers to deploy FLSs to render the illumination. The worst case complexity of this heuristic is O(ψ×α). It may perform fewer comparisons than MinDist because dispatchers are removed from the list. At the same time, in each iteration, it performs more work when compared with MinDist because it can consider the travel time of an FLS to adjust the quota of a dispatcher and potentially reset the quota of all dispatchers. Similar to MinDist, its second for loop deploys FLSs. This step may be performed by dispatchers in parallel similar to MinDist.

With QuotaBalanced, dispatchers may deploy FLSs that cross paths and potentially crash with one another. Dispatchers detect such conflicts by sharing the flight path and deployment time of their FLSs with one another. Prior to deploying an FLS, a dispatcher may detect a conflict with other deployed FLSs traveling to their target point. It may implement a variety of techniques to prevent crashes. A simple preventive technique may include a detecting dispatcher configured to delay deployment of its FLS by the flight time of the conflicting FLS, increasing the latency to render an illumination. A more sophisticated technique may include computing a different flight path for the conflicting FLS, eliminating crashes.

The Princeton Shape Benchmark can highlight the quantitative and qualitative differences between MinDist and QuotaBalanced. The Princeton Shape Benchmark contains a database of 1,814 3D models. Results are shown from 1 model, the race car (m1510 in the Princeton Shape Benchmark), as the findings are substantially identical across all models. The race car model includes 11,894 points.

TABLE 2
MinDist vs. QuotaBalanced

| | MinDist | QuotaBalanced |
|---|---|---|
| Illumination Latency (Seconds) | 661 | 163 |
| Distance Travelled (Cells) | 494,938 | 1,122,947 |
| Intersecting flight paths | 0 | 35 |
| FLS Conflicts | 0 | 12 |
| Execution Time (Milliseconds) | 27.71 | 27.44 |

In this example, simulator assumes an FLS display that is a cube with length=100, height=100, and depth=100 cells. This display consists of 8 dispatchers, one at each corner of the cuboid. Each dispatcher may deploy 10 FLSs per second, one FLS every 100 milliseconds. The speed of each FLS may be 4 cells per second. An FLS flies along a straight line from the location of its dispatcher to the coordinates of its assigned point. While QuotaBalanced uses all 8 dispatchers to deploy FLSs, MinDist uses only 2 at the bottom corner of the display. Hence, QuotaBalanced enhances latency four folds, as shown in the first row of Table 2. This comes at a cost, namely, an increase in the total distance travelled by the FLSs. This metric may be more than 2× higher with QuotaBalanced, as shown in the second row of Table 2. This translates into a higher energy consumption to enhance latency.

QuotaBalanced can exhaust the list of active dispatchers and resets their quota (Lines 18-21 of FIG. 3) 1393 times with this model.

Dispatchers can detect when the path of their deployed FLSs intersect one another, identifying a conflict that may result in FLSs crashes. QuotaBalanced incurs 35 such conflicts. Not every detected conflict is a crash because one FLS may fly past the crash point in advance of the other conflicting FLSs. In our study, FLSs can be in 20% proximity of one another to be considered as conflicting. Table 2 shows QuotaBalanced incurs 12 such conflicts. This is because dispatchers deploy FLSs that are farther away from a point in the display coordinate system than the other dispatchers. This is a small percentage (0.1%) of the 11,894 deployed FLSs by the 8 dispatchers.

A motion illumination can include a sequence of point clouds displayed at a pre-specified rate. Assuming an FLS corresponds to a point, a display can compute both travel path of FLSs and their change of color from one point cloud Ξᵢ to the next Ξᵢ₊₁. While these changes may be minor with point clouds that constitute a scene, they may be drastic from the last point cloud of one scene to the first point cloud of its following scene. This paper focuses on computing the intra-scene travel paths, deferring inter-scene travel paths to future work.

To render a scene, the display can assign an FLS to each point of its first point cloud Ξ₁. This is identical to rendering a static illumination. Thus, either MinDist or QuotaBalanced maybe used. To render its subsequent point cloud Ξ₂, the Orchestrator can compute whether Ξ₂ consists of more points than Ξ₁, such that additional FLSs are needed to render Ξ₂. The Orchestrator can compute whether Ξ₂ consists of fewer points than Ξ₁, such that some Ξ₁ FLSs go dark or fly to a charging station to render Ξ₂. Dark FLSs may be used in a subsequent point cloud, say Ξ₃. Maintaining them in their current location may result in a lower travel distance than having them fly back to a charging station only to be replaced by another FLS deployed for Ξ₃ by a dispatcher. The Orchestrator can compute whether Ξ₁ FLS remains stationary and changes color in Ξ₂. The Orchestrator can compute whether Ξ₁ FLS flies to a new position and displays either the same or a different color in Ξ₂. The Orchestrator can compute whether Ξ₁ FLS remains stationary and continues to display its current color in Ξ₂. This is the scenario where the point in Ξ₁ and Ξ₂ are identical, i.e., have the same coordinate and render the same color. Any and all combinations of these possibilities may apply when considering two point clouds Ξᵢ and Ξᵢ₊₁. With Scenario 1, dark FLSs from a previous cloud point (say Ξᵢ₋₁) may be used to render a subsequent Ξ₂. If none are available, the FLSs can be deployed by a dispatcher.

Various processes, Simple and Motill, can detect the alternative scenarios and compute FLS flight paths and color renderings. Similar to MPEG encoding, the display may execute these processes once for a motion illumination, store their computed flight paths, and reuse this information for future renderings.

Simple is a process that includes two steps. In the first step, it computes the flight path of FLSs between all pairs of point clouds Ξᵢ and Ξᵢ₊₁ that constitute a scene. This step assigns a flight path to each point cloud Ξᵢ. In addition, it identifies those FLSs of Ξᵢ that are extras and may be used in a subsequent point cloud, δᵢ. In a second pass, Simple processes δᵢ to decide whether they should stay in the display grid and go dark or fly back to a charging station. Simple's objective with both steps is to minimize the total distance travelled by FLSs. Below, we describe the two steps in turn. Simple constructs a hash table on the coordinates of Ξi and probes it with coordinates of Ξi+1. For each match, it checks whether the color of the probing point is the same or different. If they are the same, it has identified a point that belongs to Scenario 5. If different, it has identified a point that belongs to Scenario 3. If the point from Ξᵢ₊₁ has no match then it is added to set μᵢ₊₁. This point is a candidate for Scenario 4 if Ξᵢ and Ξi₊₁ consist of the same number of points. It is a candidate for Scenario 1 (Scenario 2) if Ξᵢ has more (fewer) points than Ξᵢ₊₁. Simple deletes a hash table entry that matches a coordinate of Ξᵢ₊₁. Once all points of Ξᵢ₊₁ have probed the hash table, Simple enumerates those points that remain in the hash table and assigns them to δᵢ. δᵢ correspond to Ξᵢ points with no matches in Ξᵢ₊₁. These are FLSs that are rendering Ξᵢ and are freed in Ξᵢ₊₁. In an example, Simple may require these freed FLSs to fly to a new coordinate and change color (including going dark) to render a point of Ξᵢ₊₁ that appears in μᵢ₊₁, addressing Scenarios 2 and 4 of Ξᵢ₊₁. With those that address Scenario 4, some may go dark to address the same scenario for a following point cloud, say Ξᵢ₊₂. This is handled in this step as detailed below. Simple maps points of δᵢ to μᵢ₊₁ to compute flight paths for the freed FLSs of Ξᵢ to render Ξᵢ₊₁. Simple may minimize the overall distance using the following greedy heuristic. Simple may compute the distance between every pairing of a δᵢ point with a μᵢ₊₁ point. Simple may sort these pairings of points in ascending distance. Simple may select the first pairing, assigns its δᵢ FLS to fly from its current position to the vacant coordinate of μᵢ₊₁ that requires illumination. Simple may add this flight path to its list of FLS flight paths for Ξᵢ. Simple removes the coordinates of this pairing from its list of possibilities, δᵢ, and μᵢ₊₁. It continues with the next pairing, repeating this process until either δᵢ, μᵢ₊₁, or both are empty.

If both δᵢ and μᵢ₊₁ are empty then Simple's Step 1 is complete. If δᵢ is not empty then its FLSs may be added to δᵢ₊₁. These FLSs may be candidates to go dark and may be used to render a future point cloud Ξⱼ, j>i+1. Whether the FLSs are chosen to go dark and potentially be used to render a future point cloud or whether the FLSs are required to fly back to a charging station is decided in Simple's Step 2. Once Step 1 completes, Simple has a set of flight paths ϵ and δᵢ idle FLSs for each point cloud Ξᵢ. The last point cloud of the scene is the exception, as there is not subsequent point cloud.

In Step 2, Simple analyzes δᵢ associated with each point cloud Ξᵢ as follows. If δᵢ is empty then it is deleted. If it identifies one or more FLSs then, for each FLS, Simple looks ahead to see if the FLS is used in a future point cloud Ξⱼ, j>i+1. If the FLS is not used then it can fly back to a charging station. If the FLS is used then Simple determines whether the distance is minimized by maintain the FLS in flight (Scenario 2) or having it fly back to a charging station. With the latter, an FLS can be deployed by a dispatcher and its traveled distance is considered in our analysis. Step 2 may use the amount of energy consumed by FLSs (instead of distance) to decide whether a δᵢ FLS should remain in the display or fly back to the charging station. Step 2 terminates once it has processed δᵢ of point clouds. The final flight paths for each point cloud are stored in a file to render an illumination. When rendering the illumination using this file, a display applies flight paths of ϵ to FLSs of Ξᵢ to render Ξᵢ₊₁. These flight paths may be provided to each individual FLS for as many point clouds accommodated by its storage. Periodically, the FLS may poll the Orchestrator for its remaining flight paths.

Simple can use approximately 600 seconds to compute flight paths for FLSs that constitute two consecutive point clouds. Almost all its time is spent in Step 1. This step can use time and resources by computing |μᵢ₊₁| pairings for each δᵢ FLS. Only one dictates the destination of this FLS and its flight path. Step 1 can find and delete the remaining |μᵢ₊₁|−1 possibilities. Step 1 enumerates all possible mappings from FLSs in δᵢ to the vacant coordinates in μᵢ₊₁. This can be demonstrated with an example. Assume δᵢ={P₁, P₂} and μᵢ₊₁={Q₁, Q₂}. Assume distance from P₁ to each of Q₁ and Q₂ is 1 and 2 cells, respectively. Assume distance from P₂ to each of Q₁ and Q₂ is 2 and 5 cells, respectively. The optimal minimum distance of 4 is realized by flying the FLS located at P₁ to the coordinates of Q₂, and flying the FLS at P₂ to the coordinates of Q₁. However, Step 1 maps P₁ to Q₁ because their distance is the smallest. It can subsequently map P₂ to Q₂, resulting in 6 as the total travelled distance by FLSs at P₁ and P₂.

Present implementations advantageously include Motill as a family of divide-and-conquer encoding techniques to implement Step 1 of Simple. They assume an FLS rendering a point in Ξi travels localize mapping of the points by constructing a 3D grid on the point clouds. Instead of computing the distance between a freed FLS of Ξᵢ (δᵢ) with every vacant coordinate of Ξᵢ₊₁ (μᵢ₊₁), Motill compares those in the same cuboid or its neighboring cuboids. Other pairings are guaranteed to be farther away. By eliminating them from consideration, Motill reduces complexity of Step 1 to provide a faster execution time when computing FLS flight paths. In addition, a Motill technique named ICF provides shorter flight distances for FLSs. Motill is highly parallelizable and may use multiple cores of a processor to compute flight paths. Simple is a special case of Motill with a grid consisting of 1 cuboid. Both lossy and lossless variants of Motill may be implemented. In lossy mode, Motill may remove certain points to minimize the number of FLSs used to render an illumination. In lossless mode, the number of FLSs is the same as the number of points. The focus of this papers is on the lossless Motill.

Motill partitions a scene into a sequence, a Group of Point Clouds (GPC), consisting of ω point clouds, {Ξ₁, Ξ₂, . . . , Ξ_{ω}}. Each point cloud Ξᵢ is an illumination. A point in a GPC corresponds to an FLS and Motill computes its flight path across the point clouds {Ξ₁, Ξ₂, . . . , Ξ_{ω}}. Subsequently, Motill combines flight paths computed for the different GPCs together to compute the travel path of an FLS for the entire scene. Motill processes a GPC by constructing a 3D grid on its first point cloud Ξ₁. A maximum limit θ is imposed on the number of points assigned to a cuboid. Every time a cuboid overflows, Motill breaks the cuboid into two by partitioning it along a dimension. In some implementations, a round-robin policy is used to select among the dimensions. However, it is possible to use other policies to ensure a balanced distribution of points across the cuboids. Motill superimposes a copy of the Ξ₁ grid with ρ cuboids on the remaining point clouds of a GPC, Ξ₂ to Ξ_{ω}. It populates the grid copy of Ξᵢ(i>1) by scanning its points and assigning each point to the cuboid that contains it. This step does not detect overflows and has no cuboid splits. Hence, the cuboids of these point clouds may have more points than their maximum limit.

The purpose of the grid is to localize how a point (FLS) changes position from one point cloud to the next. By using the same grid across all point clouds of a GPC, Motill localizes the changes to a few cuboids. To describe how this is accomplished, we provide a formal definition of the terms grid, cuboid, and neighboring cuboids. A grid is a 3-dimensional coordinate space consisting of ρ cuboids. Two cuboids of a grid are neighbors if their coordinate spans overlap along 2 dimensions (i.e., share a face either partially or fully) and abut along one dimension. For example, Cuboid 2 is neighbors with 1, 3, and 5. Cuboid 3 has all the shown cuboids as its neighbor.

Motill may process the ρ cuboids of Ξ₁ to Ξ_{ω}to compute FLS flight paths. Motill may process two sequential point clouds, Ξᵢ and Ξᵢ₊₁, by enumerating their respective cuboids and processing one pair at a time. We identify one such pairing as Cᵢ^{j} and Cᵢ₊₁^{j}. The subscript identifies the point cloud and the superscript identifies the cuboid. A pairing can have the same superscript value, i.e., identify the same cuboid in different grids with identical L, H, and D dimensions and neighbor sets.

Motill can use Simple's hashing technique to detect Scenarios 1-4 for each cuboid pair Cᵢ^{j} and Cᵢ₊₁^{j}. With Scenario 4, it constructs δᵢ^{j} and μᵢ₊₁^{j} for each pairing per discussions of Simple. Motill compute intra-cuboid and inter-cuboid flight paths to transition FLSs of Ξi to render Ξi+1. Intra-cuboid flight paths are local to cuboids Cᵢ^{j} and Cᵢ₊₁^{j}. Inter-cuboid flight paths may be in two from: FLSs from a different cuboid flying into Cᵢ₊₁^{j}. or FLSs from Cᵢ^{j} flying to a different cuboid in the point cloud Ξᵢ₊₁. Motill computes intra-cuboid flight paths by processing δᵢ^{j} and μᵢ₊₁^{j}, using Simple, i.e., enumerating all possible combinations, sorting, and selecting the one with the shortest distance for its flight path. It computes inter-cuboid flight paths by identifying those cuboids of Ξᵢ₊₁ that have more points than their respective Ξᵢ cuboids and those cuboids of Ξᵢ₊₁ with fewer points than their respective Ξᵢ cuboids. This results in two sets of cuboids, {C⁺} and {C⁻}. It processes one cuboid of C+ by identifying its neighbors to determine which appears in the set {C⁻}. For each such cuboid, it computes all possible mappings to select a destination point with the shortest distance. It is possible that there is no neighboring cuboid that intersects a cuboid in set {C⁻}. Motill collects these and in a final pass enumerates the points in cuboids of {C⁺} and points in cuboids of {C⁻}. It uses Simple's technique to map these points together, computing flight paths for FLSs.

Motill can include Intra-Cuboid-First (ICF) and IntraCuboid-Last (ICL). ICF computes intra-cuboid flight paths for every cuboid pairing first. For the remaining cuboids, it computes inter-cuboid flight paths. It is motivated by the insight that computing flight paths local to a cuboid minimizes distance. ICL reverses the order of these two steps, computing inter-cuboid flight paths first and intra-cuboid flight paths last. Its motivation is that computing inter-cuboid flight paths first has the benefit of more candidate FLSs in δᵢ^{j} and vacant destinations in μᵢ₊₁^{j}. Both ICF and ICL implement Step 2 of Simple. Experimental results show ICF is superior to ICL for the Rose illumination of FIG. 1B. It executes faster and minimizes the total distance travelled by FLSs for the Rose illumination of FIG. 1B. Either ICF or ICL may be preferable for various images. ICF, ICL, or a combination the two may be preferable for various animations.

Motill variants may employ parallelism at different granularity, using multi-core CPUs with minimal coordination. Motill variants such as ICF or ICL may process different GPCs that constitute a scene in parallel. A challenge is how to fuse travel paths computed for two consecutive GPCs, φ₁ and φ₂. One technique may be to repeat the last point cloud Ξ_{ω}of φ₁ as the first point cloud Ξ1 of φ2. This reduces the matching task to a simple 3D coordinate lookup of the first point cloud Ξ₁ of φ₂ using the coordinates of the last point cloud Ξ_{ω}of φ₁. For each match, the travel path for an FLS in φ₁ is concatenated with travel path from φ₂ after removing the redundant path attributed to the repeated use of Ξ_{ω}of φ₁. Second, Motill may populate the grids on Ξ₂ to Ξ_{ω}in parallel, using a different core for each point cloud. In some implementations, the structure of these grids is a copy of Ξ₁ grid. Third, Motill may compute intra-cuboid flight paths for the different cuboids in parallel. With hundreds of cuboids in a grid, Motill may use hundreds of cores concurrently. Parallel processing of intercuboid flight paths may include an extra pre-processing step to identify those cuboids considered concurrently to not share neighbors.

Motill may use the concept of stragglers to enhance latency. Given a thousand core processor, assuming certain cores are idle, Motill may use these cores to execute a copy of tasks that are taking too long to complete (consuming the result of the copy that finishes first). Stragglers waste computing resources by performing redundant work to enhance latency.

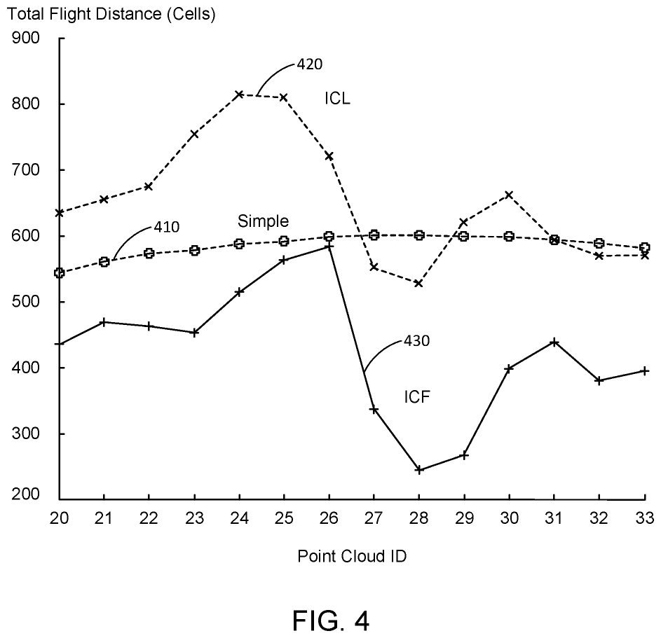

Motill and Simple. Motill with one cuboid emulates Simple. We realize this by setting the capacity of a cuboid to a large number, i.e., maximum integer value. This transforms the different variants of Motill to employ simple for intra-cuboid mappings. Motill provides a faster execution time than Simple. When configured with a reasonable number of cuboids for its grid, Motill also provides better flight paths that minimize total travelled distance as shown in FIGS. 4-7.

Simple, ICF, and ICL can be compared using the Rose illumination of FIG. 1B. This comparison uses the same software, an implementation of Motill, for all three techniques. An input parameter of Motill switches the order of intra-cuboid processing to be either first or last to use ICF or ICL, respectively. ICF's computed flight paths provide a shorter total flight distance when compared with ICL for the Rose Illumination of FIG. 1B. ICF provides comparable flight distances to Simple for most but not all pairs of point clouds for the Rose illumination of FIG. 1B. Motill's cuboid size impacts its execution time and computed flight distances. This is true with both ICF and ICL. With the Rose illumination of FIG. 1B, once FLSs are deployed using either MinDist or QuotaBalanced, the flight paths computed by the different techniques do not result in collisions. Hence, no FLS collisions are reported.

FIG. 4 shows the flight distance computed by ICL and ICF between point clouds in the Rose illumination of FIG. 1B. In FIG. 4, the x-axis identifies the point cloud in the Rose illumination from. the 20^{th} point cloud to the 33^{rd} point cloud. The y-axis shows the total distance of the flight paths computed by Simple 410, ICL 420, and ICF 430 to transition from rendering point cloud i (say 20) to the next point cloud i+1 (21). Each of Simple 410, ICL 420, and ICF 430 compute the same number of flight paths for each point cloud. (typically 2009 FLS flight paths). ICF 430 results in a lower flight distance than ICL 420 and Simple 410 for all point clouds used in FIG. 4. ICL 420 results in a higher flight distance than Simple 410 for most point clouds used in FIG. 4. The point cloud data significantly affects flight distances. As discussed above, ICF 430 has shorter flight paths than Simple 410 for point clouds where the approach in Simple prioritizes shorter flight paths between coordinate pairings which result in longer overall flight paths between point clouds. Thus, the difference between ICF 430 and Simple 410 flight paths depends on the particular point clouds of the illumination.

Simple 410 exhibits low variability over the point clouds used in FIG. 4. As Simple 410 calculates the shortest flight path between coordinate pairings, the low variability of Simple 410 may represent a low overall change in a volume of the illumination. As shown in FIG. 4, ICF 430 and ICL 420 exhibit similar variability. The difference between ICF 430 and ICL 420, the difference between ICF 430 and Simple 410, and the difference between ICL 420 and Simple 410 may represent the significance of intra-cuboid and inter-cuboid pairings for particular point clouds.

The relative total flight distance between Simple 410, ICL 420, and ICF 430 flight paths may also depend upon a frame rate of an illumination. For example, an illumination with a higher frame rate may have smaller changes between subsequent frames, or images, meaning that the difference between Simple 410, ICL 420, and ICF 430 flight paths is reduced. Additionally, the relationship between cuboid size and frame rate may further alter the difference between Simple 410, ICL 420, and ICF 430 flight paths.

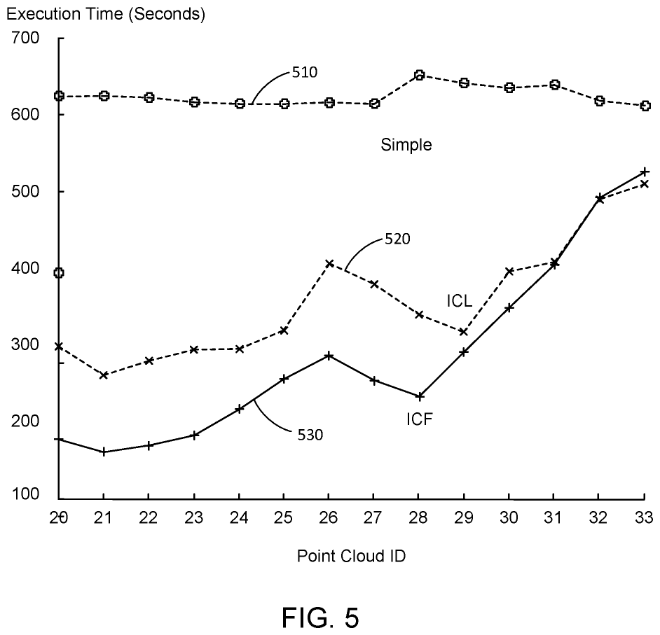

FIG. 5 illustrates a performance of execution time in view of point cloud size based on a number of FLSs. Execution times for simple 510, ICL 520, and ICF 510 are shown. ICL 520 and ICF 530 are faster than Simple 510 for all point clouds used in FIG. 5. Simple 510 is slower because it calculates all flight paths between coordinate pairs between point clouds. Both ICL 520 and ICF 530 are faster than Simple 510 as they restrict which flight paths are considered. As discussed above, ICL 520 considers inter-cuboid flight paths and then intra-cuboid flight paths and ICF 530 considers intra-cuboid flight paths and then inter-cuboid flight paths, reducing the total number of flight paths considered.

ICF 530 is faster than ICL 520 for most but not all the point clouds. With some point clouds, ICF is 5.5 to 6 times faster than Simple 510. ICF 530 is slightly (3%) slower than ICL 520 for the 33rd point cloud. Execution time for ICF 530 is faster ICL 520 for almost all point cloud pairings. In those few cases that it is slower, the percentage difference is less than 4%.

The relative difference between Simple 510, ICL 520, and ICF 530 execution times may depend upon the amount of change between point clouds, the cuboid size, the number of FLSs, and/or the variability of change within the illumination. For example, larger cuboid sizes may reduce the difference between Simple 510, ICL 520, and ICF 530 execution times, as ICL 520 and ICL 530 begin to emulate Simple 510 as the number of cuboids approaches one. In another example, the difference between Simple 510, ICL 520, and ICF 530 execution times may increase as the number of FLSs increases, as the difference between the number of flight paths considered by Simple 510 and ICF 530 and ICL 520 increases.

The point cloud data impacts FLS flight distances and Motill execution times significantly. For example, the flight distance of ICF increases linearly with the first fourteen point clouds, and t. he total distance for each of these first fourteen points is lower than that of point clouds 20-26. The cuboid size impacts Motill's execution time and computed flight distances, as shown in FIGS. 4 and 5. The cuboid size may dictate the structure of the grid and the number of cuboids included in the grid. A smaller cuboid size may result in a larger number of cuboids and slower execution times. A large cuboid size may result in fewer cuboids and faster execution times. As the cuboid size approaches the size of the volume space, Motill starts to approximate Simple. Simple (and Motill with a single cuboid) computes many combinations of possible flight paths only to select one.

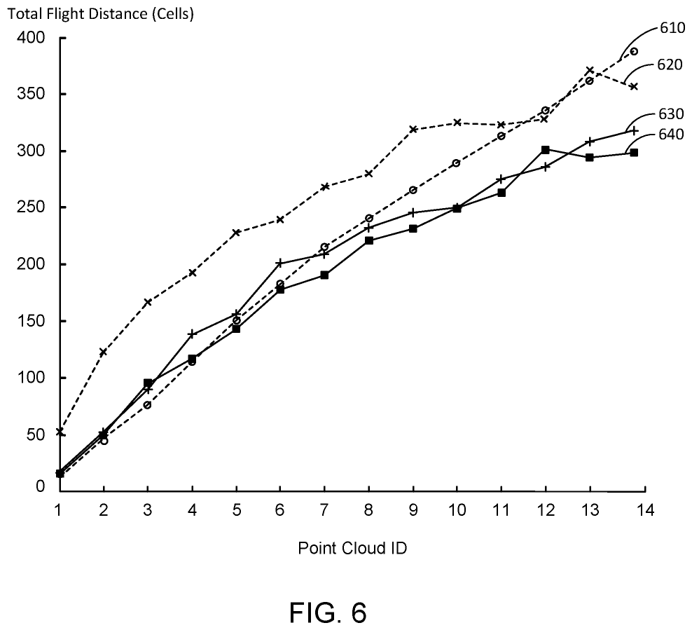

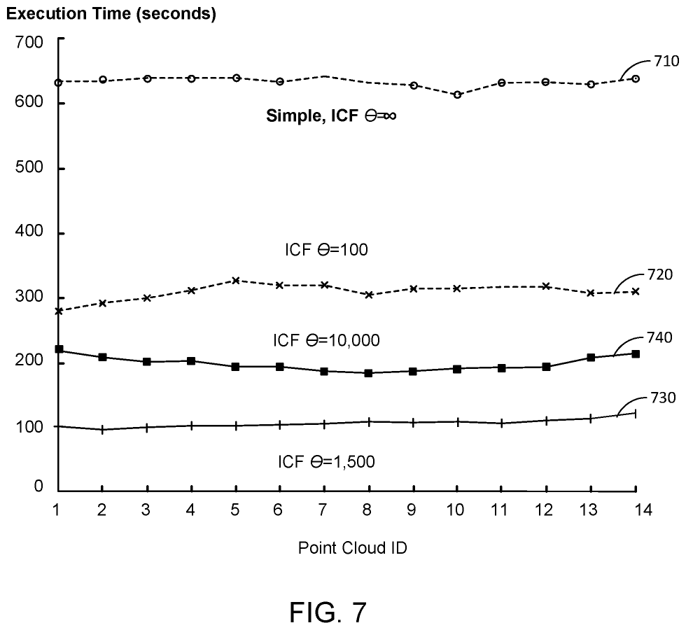

FIGS. 6-7 illustrate the impact of a size of cuboids on flight distance and execution time, respectively.

FIG. 6 illustrates total flight distance between point clouds using ICF with different cuboid sizes for the 1^{st} to 14^{th} point clouds of the Rose illumination of FIG. 1B. The x-axis identifies the point cloud in the Rose illumination and the y-axis shows the total distance of the flight paths computed to transition from rendering point cloud i (say 3) to the next point cloud i+1 (4). Total flight distances are measured between the point clouds for a maximum size cuboid 610, size “100” cuboids 620, size “1500” cuboids 630, and size “10,000” cuboids 640. Cuboid sizes are measure in cells, which may have various measurements. The maximum size cuboid 610 results in a single cuboid, as the maximum size a cuboid can have is equal to the volume space. Using a ICF with a single cuboid is equivalent to using Simple, as all FLSs and their potential flight paths are within the single cuboid and there is no distinction between intra-cuboid and inter-cuboid flight paths. The size “100” cuboids 620 result in 987 cuboids. The size “1500” cuboids 630 result in 68 cuboids. The size “10,000” cuboids 640 result in 10 cuboids.

The size “1500” cuboids 630 and the size “10,000” cuboids 640 total fight distances are shorter than the maximum size cuboid 610 flight distances for most of the point clouds used in FIG. 6. The size “100” cuboids 620 total flight distances are longer than the maximum size cuboid 610 flight distances for almost all of the point clouds used in FIG. 6.

FIG. 7 illustrates a performance of execution time in view of point cloud size based on a size of cuboids. The x-axis identifies the point cloud in the Rose illumination of FIG.

1B, and the y-axis shows the execution time in seconds to transition from rendering point cloud i (say 3) to the next point cloud i+1 (4). Execution time is measure for a maximum size cuboid 710, size “100” cuboids 720, size “1500” cuboids 730, and size “10,000” cuboids 740. Cuboid sizes are measure in cells, which may have various measurements.

The size “1500” cuboids 730 have shorter execution times for all point clouds used in FIG. 7 than the size “10,000” cuboids 740 which have shorter execution times than the size “100” cuboids 720 which have shorter execution times than the maximum size cuboid 710. The maximum size cuboid 710 has longer execution times as it computes a larger number of flight paths that are subsequently discarded than the size “100” cuboids 720, the size “1500” cuboids 730, and the size “10,000” cuboids 740. The maximum size cuboid 710 does not incur the overhead of constructing a grid, as it includes only one cuboid.

The portion of execution time used by ICF for the size “100” cuboids 720 is 18%. The rest of the execution time for the size “100” cuboids 720 is spent constructing and copying the grid. The time to copy and populate the grid with point clouds 2 to 14 is approximately the same as the time to construct the grid on point cloud 1.

For size “1500” cuboids 730, the time to construct the grid on the first point cloud is twice the time to copy the grid on the remaining point clouds, which times are approximately six times faster than the corresponding times for the size “100” cuboids 720. The portion of execution time used by ICF for the size “1500” cuboids 730 is approximately 75%.

ICF using the size “10,00” cuboids 730 spends 90% of its time computing possible flight paths that it subsequently discards. The size “10,00” cuboids 730 provides execution times that are at least 3× faster than the maximum cuboid size 710.

Execution time is affected by both the time to construct the grid in the volume space using the selected cuboid size as well as the time to calculate potential flight paths and determine the shortest flight paths to transition from one point cloud to another. The time to construct the grid does not depend upon the illumination, but the time to calculate flight paths depends upon the illumination. In general, the cuboid size may be selected to balance the overhead involved in constructing the grid against the time to calculate flight paths. For the Rose illumination of FIG. 1B, the size “1500” cuboids 730 represent the fastest execution time.

An FLS is a mechanical device that may fail. Its failure may reduce the quality of an illumination by not rendering its points. There are several types of FLS failures: rotor failures, light source failures, computing failures in the form of reboots, and battery power failures. Assuming these failures are independent and occur at a constant rate, one may compute the Mean Time To Failure of an FLS (MTTF) similar to how magnetic disk manufacturers calculate the MTTF of disk drives. The Mean Time to Degraded Illumination (MTDI) is a linear function of the number of FLSs (α) that constitute an illumination:

$$M T D I = \frac{MTTF of 1 FLS}{a} .$$

In an example, if an FLS fails once a month (MTTF of 720 hours), the MTDI of the Rose illumination of FIG. 1B with α=65,321 FLSs is 40 seconds. This is disheartening if we want to scale to illuminations consisting of millions of FLSs. Described herein are techniques to enhance MTDI of an illumination in the presence of frequent FLS failures.

FLSs may cooperate to detect failures and notify the Orchestrator of the identity of the failed FLS. This cooperation is in two forms. First, once an FLS detects its own failure, it communicates this information with its neighbors and the Hub (Orchestrator) using its networking capability. This applies to the first two forms of failures. With light source failures, the FLS flies to a Terminus immediately as it is no longer able to display an illumination. With rotor failures, it repels FLSs in its downward descent by generating frequent failed messages. Those FLSs that receive this message move away to prevent the failed FLS from crashing into them. Second, FLSs exchange periodic heartbeat messages with their neighbors in the display mesh to detect processor and battery failures. An FLS that encounters these forms of failures may not be able to notify other FLSs of its failure. Hence, FLSs can cooperate to detect such failed FLSs. If an FLS does not receive an anticipated heart beat message from one of its neighbors then it polls the neighbor. After a few failed attempts, it identifies the neighbor as having failed and communicates the identity of this failed FLS to other neighbors. This information propagates throughout the FLS swarm and the display Hub to the Orchestrator. To maintain the quality of illumination, a failed FLS can be replaced with a new one instantaneously. We realize this by deploying standby FLSs. In normal mode, standby FLSs are dark. After the discovery of a failed FLS, the standby occupies the display cell of the failed FLS and assumes its lighting responsibility to render the illumination. This occurs concurrently with the Orchestrator deploying a replacement FLS to substitute for the standby.

G FLSs neighboring one another in the display mesh form a group with one standby FLS. The minimum value of G is one, such that a standby exists for every FLS that is rendering a point. The standby FLS may mirror the flight paths assigned to its paired FLS. If an FLS fails, its standby FLS may resume its lighting and flight responsibilities. The standby FLS may replace the failed FLS immediately. A challenge associated with G=1 (one FLS per group) may be how to prevent the standbys from obstructing the user's field of view (FoV). With G>1, if the standby FLS has sufficient storage then it may maintain a copy of the flight paths assigned to the G FLSs. Otherwise, it may compute the parity of the G flight paths using xor of the bits. The resulting parity data may be the same size as the flight data assigned to an FLS in the group. Parity techniques are more space efficient than replication techniques. However, to compute the missing flight path of a failed FLS in the group, parity techniques may require the standby FLS to obtain and use the flight paths of the remaining G−1 FLSs. Using this data in combination with its parity data, the standby may compute the flight paths and illumination responsibilities of the failed FLS. With more than 1 failure in a group, the standby can wait for the Orchestrator-dispatched replacement FLSs to arrive with their flight data.

A large value of G increases the probability of two or more FLSs failing in a group simultaneously. With replication, the standby may substitute for one failed FLS. The illumination quality may suffer until the Orchestrator's dispatched replacements arrive and substitute for the other failed FLSs.

The G FLSs that participate in a group can be in close proximity of one another. This minimizes the distance travelled (time) by a standby to substitute for a failed FLS. If the group is using a parity scheme, close proximity also provides for local communication between the standby and the remaining G−1 FLSs for the standby to obtain their flight paths and lighting responsibilities to compute the failed FLS's flight path and lighting responsibilities. FLS group construction may be a weighted matching problem which can be addressed using centralized, distributed, and/or decentralized processes. With static illuminations, one may adapt these for use by the Orchestrator, multiple dispatchers, and millions of FLSs, respectively.

With motion illuminations, the position of some FLSs will change from one point cloud to the next. This may change the distance between FLSs that constitute a group. The FLSs may re-construct the groups using decentralized process. In an example, reconstructing the groups using decentralized processes may require re-assignment of standby FLSs. With a parity technique, an impacted standby can re-compute its parity information for the new group. With replication, the standby can delete flight paths and lighting pattern of FLSs that it is no longer responsible for and obtain a copy of the flight paths and lighting patterns of the new FLSs that it may substitute for. To minimize the amount of exchanged data, a display may relax the value of G for evolving groups, allowing some groups to consist of more than G FLSs and others to consist of fewer than G FLSs. In an example, FLS membership for the group may be maintained and the standby FLS may adjust its position to have approximately the same distance to the different FLSs that constitute the group. If the FLS reliability is heterogeneous, the standby may position itself closer to those FLSs with a higher failure probability. Yet another possibility is to remove the constraint that each FLS can belong to a group. This enables an FLS to leave a group, provide its illumination for a few point clouds without being a part of a group, and possibly join another group. Once it joins a group, the standby of the impacted groups can adjust its membership information and replicated/parity data. An FLS crucial to the illumination may be provided with a mirror standby.

For example, reliability models of can establish the MTDI of an illumination using groups. MTTF of a group is defined as,

$${MTTF}_{Group} = \frac{{MTTF}_{FLX}}{G + 1} \times \frac{1}{P}$$

where P is the probability of another FLS failure in a group before restoring the group to normal mode of operation,

$$P = \frac{MTTR}{{MTTF}_{FLS} / ( g + 1 )} .$$

MTTR is the Mean Time To Repair a group with a failed FLS to normal mode of operation. It is the amount of time elapsed from when an FLS fails to the time the group is restored to normal mode of operation with a replacement FLS. The Mean Time to Degraded Illumination is:

$$M T D I = \frac{G \times {MTTF}_{Group}}{a}$$

where α is the number of FLSs to render an illumination.

Table 3 shows MTDI of the Rose illumination of FIG. 1B assuming an FLS fails once a month and the system's MTTR is 1 second. Reliability groups enhances MTDI from 40 seconds to almost two months with 20 FLSs in a group, G=20. This is enhanced almost two folds (to 111 days) with 10 FLSs per group, G=10. In an example, with G=10, the Rose illumination requires approximately 6,400 additional FLSs.

TABLE 3
Reliability Groups enhance MTDI of the Rose illumination
from 40 seconds to more than a month.

| | G = 10 | G = 20 |
|---|---|---|
| Total Number of FLSs | 71,853 (1.1α) | 68,588 (1.05α) |
| Overhead Cost | 10% | 5% |
| MTDI (Hours) | 2670 | 1399 |

STAG is a novel process that staggers charging of FLS batteries as a function of time with the objective to minimize both the number of charging stations and the overall number of FLSs required to render an illumination. STAG has an initial startup overhead. This overhead is in the form of either a higher latency when rendering an illumination or wasted energy. STAG may trade one for the other. STAG has various characteristics. First, each FLS has a battery that provides a finite flight time β when fully charged. Second, Ω time units are needed to fully charge a depleted battery with minimal or no remaining flight time left. Third, the time to charge an FLS battery, λ, is a linear function of β and its remaining flight time

$$λ = \frac{Ω * r}{β} .$$

An FLS computes the amount of battery flight time required for it to fly to a charging station using its distance to the charging station. Once its battery flight time reaches this threshold, the FLS will go dark and fly to the charging station. A standby FLS will substitute for this FLS to perform its lighting responsibility while a dispatcher will deploy an FLS with β flight time to substitute for the standby.

It is important to minimize the window of time Δ for a battery depleted FLS_{d} to switch places with a fully charged FLS_{c}. Should an FLS belonging to the parity group of FLS_{d} fail during Δ, this results in loss of information with a light missing from the illumination. Consider an illumination with α FLSs and assume the time to charge the battery of each FLS equals its flight time on a fully charged battery, ω=β. A naive process (Naïve) may deploy all a FLSs at one instance in time. After β time units, all FLSs can fly back to a charging station while the dispatchers deploy α fully charged FLSs. Naive repeats this process every time units while rendering the illumination.

Naive has several characteristics. First, it can use 2α FLSs to render an illumination: α FLSs charge while α FLSs render the illumination. Second, there is an exchange step when fully changed FLSs and fully depleted FLSs switch places. The illumination may become distorted during this period because almost all FLSs that constitute an illumination may go dark in order to switch places with fully charged FLSs. Moreover, the process that manages FLSs during this period has a high complexity as it can manage flight patterns of 2α FLSs. STAG staggers FLSs as a function of time to prevent them from exhausting their finite flight time at the same time. It overlaps charging of some FLSs with others that are rendering an illumination, eliminating Naive's exchange step. In its steady state, STAG switches a fully charged FLSs with a fully depleted FLSs continuously.

STAG constructs h flocks of FLSs. A flock i consists of αᵢ FLSs. Within a flock i, STAG staggers its αᵢ FLSs such that their remaining battery flight time ranges from β down to the staggering interval

$$S = \frac{β}{{a}_{i}} .$$

More formally, assuming the FLSs in a flock are numbered from 1 to αᵢ, the remaining flight time of FLS j is

$$β ( j ) = \frac{j * β}{{a}_{i}} .$$

Thus, FLS j=αi has a fully charged battery with β flight time. The staggering time interval S is the minimum flight time required by an FLS to travel to a charging station. The number of FLSs charging (or staged in a hangar) to substitute for an FLS of Flock i FLS is

$$⌈ \frac{Ω}{S} ⌉ .$$

In an example, the number of FLSs charging to substitute for the FLS of Flock i may be the extra number of FLSs required by a flock to render an illumination. The total number of FLSs that are charging (or staged in a hangar) may be

$$h \times ⌈ \frac{Ω}{S} ⌉ .$$

Thus, STAG minimizes the number of additional FLSs to render an illumination.

An FLS spends β time units rendering an illumination and Ω time units charging. The fraction of time an FLS spends illuminating is

$$\frac{β}{Ω + β} .$$

The minimum number of FLSs, Ψ, to render an illumination consisting of α FLSs can satisfy the following equality:

$$\frac{β}{Ω + β} Ψ = α .$$

Solving for Ψ, one obtains:

$$Ψ = α + α \frac{Ω}{β} \qquad ( 1 )$$

In an example, a minimum of

$$α \frac{Ω}{β}$$

additional FLSs are used to render the illumination. STAG uses

$$\frac{Ω}{S}$$

additional FLSs. Substituting the definition of S,

$$\frac{β}{a} ,$$

in this equation produces

$$α \frac{Ω}{β} .$$

This is the minimum number of additional FLSs in Equation 1.

In an example, an illumination includes 5 FLSs. These FLSs are assigned to 1 flock, h=1. The time to charge an empty FLS battery is 3 minutes and each FLS provides 15 minutes of flight time on a fully charged battery, Ω=3 and β=15. STAG interleaves the charging of the 5 FLSs such that each FLS is staggered S=5 minutes of flight time apart,

$$S = \frac{β = 15}{Ω = 3} .$$

The extra number of FLSs is 2,

$$⌈ \frac{Ω = 5}{S = 3} ⌉ .$$

While 2 FLSs are charging, 5 FLSs render the illumination. Every 3 minutes, the Orchestrator deploys a fully charged FLS to render the illumination. It replaces an FLS with an almost depleted battery that returns to a charging station to be charged. This FLS spends 3 minutes in a charging station. Subsequently, the Orchestrator deploys it to substitute for another FLS in the flock with an almost depleted battery. The number of FLSs in transit from a charging station to an illumination is 2 h. With h=1, there are 2 FLSs in transit. One flying from the illumination to a charging station and a second from a charging station to the illumination. A display can ensure these FLSs are not in the user's field of view.

Given a particular swarm of FLSs, reducing its number of flocks to one, h=1, minimizes the number of FLSs in transit. This reduces the likelihood of an in-transit FLS obstructing the user's field of view. However, in some implementations, the number of flocks can be defined by the time for an FLS to fly back to the charging station (S_{threshold}) and the number of FLSs for an illumination α. With an illumination that consists of a large number of FLSs, maintaining h at one results in a small staggering interval S (because S is a function of the number of FLSs in a flock). Its lower bound may be Sₜₕᵣₑₛₕₒₗ. This dictates the number of FLSs in a flock

$${a}_{i} = \frac{β}{{s}_{t h r e s h o l d}}$$

which in turns dictates the number of flocks,

$$h = ⌈ \frac{a}{{a}_{i}} ⌉ .$$

With STAG, flocks can be logical. Unlike the failure handling groups, there is no constraint on flocks to be in close proximity of one another. However, similar to forming groups, the problem of matching flocks may be addressed using centralized and/or decentralized processes. An FLS display may adapt one of these techniques to form STAG's flocks. A centralized technique for formation of cliques may include the Orchestrator computing the number of flocks and the quota for each flock, i.e., the number of FLSs for each flock. It assigns flock ids to different dispatchers that deploy FLSs. The dispatchers assign flock ids to their deployed FLSs until the quota for a given flock id is exhausted.

STAG can stagger the battery lifetime of FLSs in a flock when an illumination is first initiated. One approach is to deploy FLSs of a flock every S time units. The limitation of this approach is that it introduces a delay of αᵢ×S time units before the illumination is rendered, its latency. With large values of αᵢ and S, this latency may be substantial. In an example, with the 65,321 FLSs required by the Rose illumination of FIG. 1B, assuming S is 100 milliseconds, the startup latency to render the illumination is more than 10 minutes. In another example, STAG may consume energy by requiring dispatchers to deploy FLSs with full batteries as fast as possible and require FLSs with partially full batteries to fly back to be recharged.

In an example, relative to time T when five FLSs are deployed, a first FLS flies back after T+3 minutes to fully charge its battery while a second FLS flies to substitute for the first FLS. A third FLS flies back after T+6 minutes to fully charge its battery while the first FLS flies to substitute for the third FLS. A fourth FLS flies back after T+9 minutes to fully charge its battery while the third FLS flies to substitute for the fourth FLS. Note that the first FLS and the third FLS have partial flight time left and are staggered in time. The ordering can be defined by the ID of the FLSs and may be implemented in a decentralized manner. When the first FLS fly's back, the second FLS (or another extra FLS) flies to substitute for it and assume an ID of the first FLS. When the third FLS flies back, the first FLS is fully charged and substitutes for the third FLS. This continues a few more iterations until it reaches a steady state. In this state, the remaining flight time of an FLSj is almost fully exhausted before it flies back to the charging station and a fully charged FLS is deployed to substitute in FLSe's vacant cell (or the cell occupied by its standby). Returning FLSs with partially charged batteries to a charging station to become fully charged wastes energy relative to almost fully exhausting the remaining flight time of the FLSj. Thus, a tradeoff between the two techniques is startup latency versus wasted energy. A hybrid of the two is possible where a technique specifies an upper bound on either the amount of energy or the tolerable startup latency.

TABLE 4
STAG with the Rose illumination and different β and Ω values.

| | β = 5 min | β = 10 min | β = 20 min |
|---|---|---|---|
| | Ω = 10 min | Ω = 5 min | Ω = 2.5 min |
| h, number of flocks | 218 | 109 | 55 |
| αi, FLSs/Flock | 300 | 600 | 1200 |
| Extra FLSs per Flock | 600 | 300 | 150 |
| FLSs for the last Flock | 221 | 521 | 521 |
| S for the last flock (Millisec) | 1358 | 1152 | 2303 |
| Extra FLSs for the last flock | 442 | 261 | 65.125 |
| Extra FLSs for the | 130642 | 32661 | 8166 |
| illumination | | | |
| Overhead Cost | 200% | 50% | 12.5% |
| Total Number of FLSs | 195,963 | 97,982 | 73,487 |

Table 4 quantifies the behavior of STAG with different β and Ω values. The first column pertains to the flight time and battery charge time of today's Sky Viper Dash Nano Drone (with approximate cost of $17). The other two columns correspond to future generations of such a device with flight time on a fully charged battery (β) doubling and the time to charge (Ω) its battery is halved. The lower bound on S can be 1 second. It limits the number of FLSs in a flock, αi, shown in the 2nd row of Table 4. The number of FLSs that constitute the Rose illumination of FIG. 1B (α=65,321) is not an even multiple of αi. Hence, the middle 3 rows show the characteristics of the last flock that has the remaining FLSs. Note that its value of S is higher than 1 second (1000 milliseconds) because it has fewer FLSs.

The characteristics of an example battery increases the number of FLSs to render the Rose illumination of FIG. 1B three-fold. This is a 200% overhead. This overhead decreases linearly as we enhance battery characteristics, as shown in the second to last row of Table 4. With an 8-fold overall improvement in battery characteristics (4 fold enhancement of β and 4 fold reduction of (Ω), STAG's overhead decreases to 12.5%.

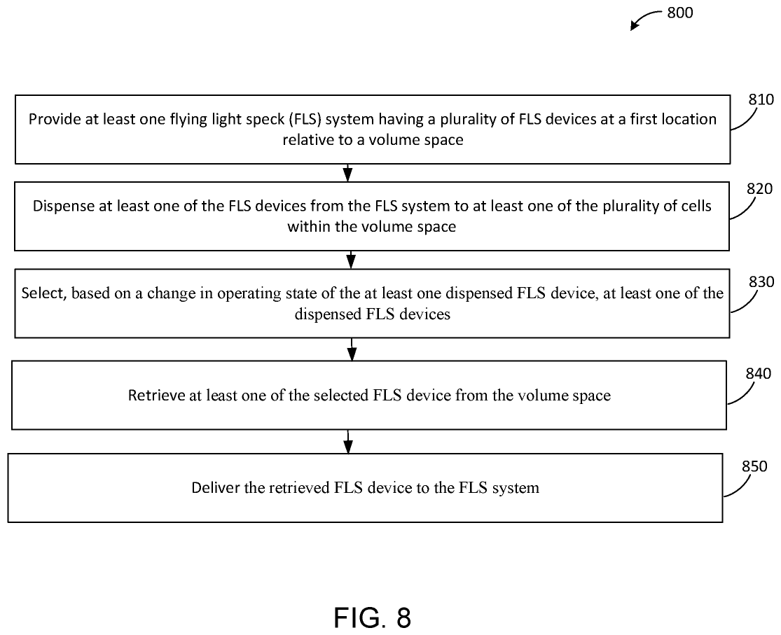

FIG. 8 illustrates an example method 800 for managing changes in operating state of FLSs. At least the system 100 of FIG. 1A and the computer architecture 200 of FIG. 2 can perform the method 800. The method 800 may include more, fewer, or different operations than shown. The operations can be performed in the order shown, in a different order, or concurrently.

At 810, at least one flying light speck (FLS) system having a plurality of FLS devices may be provided at a first location relative to a volume space. In some embodiments, the volume space may be a cuboid-shaped volume space. The volume space may include a plurality of cells. The plurality of cells may each be a cuboid portion of the volume space. A projection volume may be defined in the volume space. The projection volume can be defined by a single processor, by multiple processors working in parallel, and/or by multiple processors working in sequence. The volume space may be a three-dimensional space. The volume space may be a three-dimensional space bounded by one or more objects or surfaces, such as a desktop. The projection volume may be a three-dimensional volume less than or equal to the volume space. Defining the projection volume may include determining a size of an illumination to be rendered in the projection volume, determining a viewing angle of the illumination, and/or determining locations of one or more hangers.

In some embodiments, providing the at least one FLS system includes providing one or more of a plurality of FLS systems at corresponding one or more different locations adjacent the volume space. In an example, four FLS systems are placed at lower four corners of a cuboid-shaped volume space.

At 820, at least one of the FLS devices may be dispensed from the FLS system to at least one of the plurality of cells within the volume space. In some embodiments, a single FLS device occupies a single cell. The size of the cells may be based on a volume illuminated by a single FLS device. The volume illuminated by a single FLS device may be an illumination cell. In some embodiments, an illumination cell includes 125 display cells. The plurality of cells may include illumination cells or display cells. Dispensing the at least one FLS device to the at least one cell may include directing the FLS device along a flight path from a hanger of the FLS system to the cell. Dispensing the at least one FLS device may include dispensing a plurality of FLS devices from the FLS system to at least one of the plurality of cells within the volume space.

At 830, at least one of the dispensed FLS devices may be selected based on a change in operating state of the at least one dispensed FLS device. The change in operating state may include, but is not limited to, a change in battery level below a predetermined threshold, a mechanical malfunction, or a failure to transmit a heartbeat signal. The change in operating state may include a failure of at least one component of the FLS device.

At 840, at least one of the selected FLS devices may be retrieved from the volume space. Retrieving the at least one of the selected FLS device may include directing the FLS along a flight path from the volume space. In some embodiments, the FLS device may be retrieved by a garbage collector, such as a separate FLS device.

At 850, the retrieved FLS device may be delivered to the FLS system. The FLS system may determine a cause of the change in operating state of the retrieved FLS device. In some embodiments, the FLS system may discard or recycle the FLS device. In some embodiments, the FLS system may recharge the FLS device.

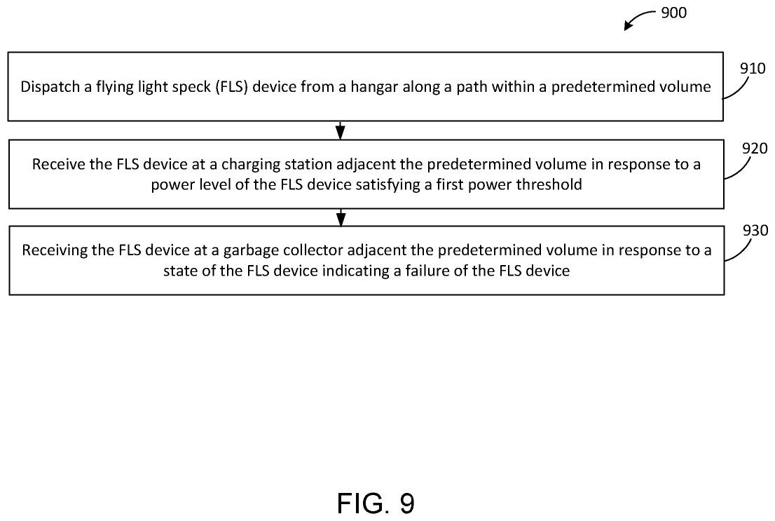

FIG. 9 illustrates an example method 900 for managing battery charge levels and failures of FLS devices. At least the system 100 of FIG. 1A and the computer architecture 200 of FIG. 2 can perform the method 900. The method 800 may include more, fewer, or different operations than shown. The operations can be performed in the order shown, in a different order, or concurrently.

At 910, a flying light speck (FLS) device may be dispatched from a hangar along a path within a predetermined volume. In some embodiments, the FLS device includes a plurality of FLS devices such that the plurality of FLS devices may be dispatched from the hangar along paths within the predetermined volume. In some embodiments, the plurality of FLS devices include at least one thousand, 10,000, or 100,000 FLS devices. In some embodiments, the predetermined volume includes a plurality of cells.

At 920, the FLS device may be received at a charging station adjacent the predetermined volume in response to a power level of the FLS device satisfying a first power threshold. In some embodiments, the hanger includes the charging station. In some embodiments, a plurality of hangars each include a corresponding charging station. In some embodiments, a plurality of hangars share a common charging station.

At 930, the FLS device may be received at a garbage collector adjacent the predetermined volume in response to a state of the FLS device indicating a failure of the FLS device. In some embodiments, the FLS flies to the garbage collector. In some embodiments, the FLS device may be retrieved from the volume space by another FLS device or another device.

The method 900 may further include dispatching the FLS device from the charging station into the predetermined volume, in response to the power level of the FLS device satisfying a second power threshold. In some embodiments, the FLS device may be discharged into the predetermined volume once it is recharged, or once it is recharged above a predetermined threshold. The method 900 may further include dispatching a second FLS device from the hangar into the predetermined volume, in response to the state of the FLS device indicating the failure of the FLS device. The second FLS device may be dispatched form the hangar based on a charge of the FLs device falling below a predetermined threshold. The second FLS device may replace the FLS device in the predetermined volume.

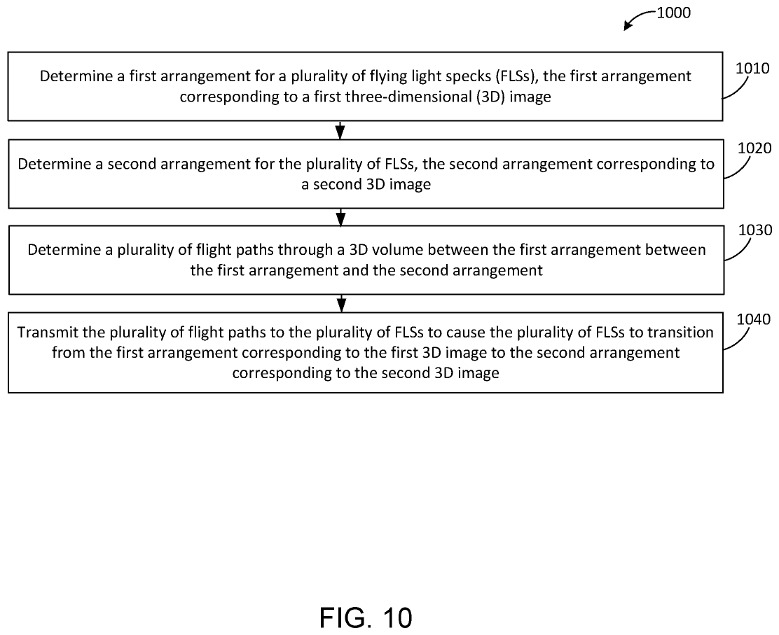

FIG. 10 illustrates an example method 1000 for transitioning from a first arrangement to a second arrangement. At least the system 100 of FIG. 1A and the computer architecture 200 of FIG. 2 can perform the method 1000.

At 1010, a first arrangement for a plurality of flying light specks (FLSs) may be determined, the first arrangement corresponding to a first three-dimensional (3D) image.

At 1020, a second arrangement for the plurality of FLSs may be determined, the second arrangement corresponding to a second 3D image. In some embodiments, the second 3D image may be a variant of the first 3D image. In some embodiments, the first and second 3D images are subsequent frames of a 3D animation.

At 1030, a plurality of flight paths may be determined through a 3D volume between the first arrangement and the second arrangement. In some embodiments, determining the plurality of flight paths includes determining a location in the first arrangement of a first FLS of the plurality of FLSs, determining a location in the second arrangement of the first FLS, determining a shortest path between the location in the first arrangement and the location in the second arrangement of the first FLS. In some embodiments, determining the plurality of flight paths includes comparing coordinates of the second arrangement to coordinates of the first arrangement, identifying a subset of the plurality of FLSs whose coordinates in the second arrangement do not match their coordinates in the first arrangement, and determining flight paths for the subset of the plurality of FLSs. In some embodiments, comparing the coordinates of the second arrangement to the coordinates of the first arrangement includes generating a hash table on the coordinates of the first arrangement and probing the hash table using the coordinates of the second arrangement.

In some embodiments, determining the plurality of flight paths incudes identifying a first unit of a grid corresponding to the first arrangement, comparing coordinates of FLSs in the first unit of the grid in the first arrangement with coordinates of the FLSs in the first unit of the grid in the second arrangement, identifying a subset of the FLSs in the first unit of the grid whose coordinates in the second arrangement do not match their coordinates in the first arrangement, and determining flight paths for the subset of FLSs in the first unit of the grid. In some embodiments, the coordinates of the subset of the FLSs in the first unit of the grid in the second arrangement are within the first unit of the grid. In some embodiments, the method 1000 includes rendering images at a predetermined frequency to generate an animated sequence of images. In some embodiments, the predetermined frequency may be equal to or greater than 24 images per second, 30 images per second, 60 images per second, or 120 images per second.

In some embodiments, the second arrangement includes a greater number of FLSs than the first arrangement and determining the plurality of flight paths includes identifying an additional FLS and determining a flight path from a current location of the additional FLS to the second arrangement. In some embodiments, the second arrangement includes a lower number of FLSs than the first arrangement and determining the plurality of flight paths includes identifying a first FLS of the plurality of FLSs and determining a flight path for the first FLS from the first arrangement to a location separate from the separate arrangement. In some embodiments, the method 1000 includes determining that the first FLS may be not in a third arrangement corresponding to a third 3D image and determining a flight path for the first FLS from the location separate from the second arrangement to a hangar. In some embodiments, the method of 1000 includes identifying an issue with a second FLS of the plurality of FLSs and determining a flight path for the first FLS to replace the second FLs in the second arrangement.

At 1040, the plurality of flight paths may be transmitted to the plurality of FLSs to cause the plurality of FLSs to transition from the first arrangement corresponding tot the first 3D image to the second arrangement corresponding to the second 3D image.

In some embodiments, the movement of the FLSs in transitioning from the first 3D image to the second 3D image results in apparent movement of an object rendered in the first 3D image and the second 3D image. A number of FLSs in the first and second 3D images may result in an apparent image in which the naked eye, at a predetermined distance, cannot distinguish individual FLSs. The more FLSs are used in rendering the first and second 3D images, the faster the FLSs move between the first image and the second image, and the faster the flight paths to transition from the first 3D image to the second 3D image, the better the apparent animation will appear to be. Animating 3D images using hundreds of FLSs at 24 frames or images per second would not be achievable by any manual or mental process, much less animating 3D images using thousands of FLSs at higher frame rates.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

1. A method of controlling one or more flying light speck (FLS) devices, the method comprising:
providing at least one FLS system having a plurality of FLS devices at a first location relative to a volume space having a plurality of cells;
dispensing, by a dispenser, at least one of the FLS devices from the FLS system to at least one of the plurality of cells within the volume space;
selecting, based on a change in operating state of the at least one dispensed FLS device, at least one of the dispensed FLS devices;
retrieving, by a garbage collector, at least one of the selected FLS devices from the volume space; and
delivering, by the garbage collector, the retrieved FLS device to the FLS system upon an indication of failure of the at least one of the selected FLS devices.

2. The method of claim 1, the change in operating state comprising a failure of at least one component of the further FLS device or a discharge of a battery of the further FLS device below a predetermined threshold.

3. (canceled)

4. The method of claim 1, wherein the volume space comprises a cuboid shaped volume space, and wherein each of the plurality of cells comprises a cuboid portion of the volume space.

5. (canceled)

6. The method of claim 1, wherein the plurality of cells are defined by a logical relationship between the plurality of FLS device, wherein the logical relationship includes a downwash of the plurality of FLS devices.

7. (canceled)

8. (canceled)

9. The method of claim 1, wherein the providing the at least one FLS system comprises one of:
providing one or more of a plurality of FLS systems at corresponding one or more different locations adjacent to the volume space,
providing one or more of a plurality of FLS systems at corresponding one or more different locations within the volume space, or
providing one or more of a plurality of FLS systems at one or more respective corners of the volume space, wherein the volume space comprises a cuboid volume space.

10. (canceled)

11. (canceled)

12. The method of claim 1, further comprising:
dispensing a second FLS device from the FLS system to replace the retrieved FLS device, wherein the second FLS device occupies a standby position within the volume space when the change in operating state occurs.

13. (canceled)

14. The method of claim 1, wherein each of the plurality of FLS devices comprises a storage, a processor, a communication interface, one or more sensors and at least one of: a light source or a reflective surface.

15. (canceled)

16. (canceled)

17. The method of claim 14, wherein each respective FLS device of the plurality of FLS devices can localize a position of the respective FLS device relative to one or more other FLS devices of the plurality of FLS devices using the one or more sensors, wherein the method further comprises: transmitting a message to the plurality of FLS devices to synchronize clocks of the plurality of FLS devices with a predetermined error, wherein an accuracy of the localization is based on the predetermined error.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. A method comprising:
determining a first arrangement of a plurality of flying light specks (FLSs), the first arrangement corresponding to a first three-dimensional (3D) image;
determining a second arrangement of the plurality of FLSs, the second arrangement corresponding to a second three-dimensional (3D) image;
determining a plurality of paths through a 3D volume between the first arrangement and the second arrangement; and
transmitting the plurality of paths to the plurality of FLSs to cause the plurality of FLSs to transition from the first arrangement corresponding to the first 3D image to the second arrangement corresponding to the second 3D image; and
rendering images at a predetermined frequency to generate an animated sequence of images, wherein the predetermined frequency is equal to or greater than 24 images per second.

43. The method of claim 42, wherein determining the plurality of flight paths comprises:
determining a location in the first arrangement of a first FLS of the plurality of FLSs;
determining a location in the second arrangement of the first FLS; and
determining a shortest path between the location in the first arrangement and the location in the second arrangement of the first FLS.

44. The method of claim 42, wherein the second arrangement includes a greater number of FLSs than the first arrangement, and wherein determining the plurality of flight paths comprises:
identifying an additional FLS; and
determining a flight path from a current location of the additional FLS to the second arrangement.

45. The method of claim 42, wherein the second arrangement includes a lower number of FLSs than the first arrangement, and wherein determining the plurality of flight paths comprises:
identifying a first FLS of the plurality of FLSs; and
determining a flight path for the first FLS from the first arrangement to a location separate from the second arrangement, wherein the flight path for the first FLS from the first arrangement to a location separate from the second arrangement avoids a view of a user;
determining that the first FLS is not in a third arrangement; and
determining a flight path for the first FLS from the location separate from the second arrangement to a hangar or charging station.

46. (canceled)

47. The method of claim 45, further comprising:
determining that the first FLS is not in a third arrangement; and
determining a flight path for the first FLS from the location separate from the second arrangement to a hangar or charging station.

48. The method of claim 45, further comprising:
identifying an issue with a second FLS of the plurality of FLSs; and
determining a flight path for the first FLS to replace the second FLS in the second arrangement.

49. The method of claim 42, wherein determining the plurality of flight paths comprises:
comparing coordinates of the second arrangement to coordinates of the first arrangement by:
generating an index structure on the coordinates of the first arrangement; and
probing the index structure using the coordinates of the second arrangement;
identifying a subset of the plurality of FLSs whose coordinates in the second arrangement do not match their coordinates in the first arrangement; and
determining flight paths for the subset of the plurality of FLSs.

50. (canceled)

51. The method of claim 42, wherein determining the plurality of flight paths comprises:
identifying a first unit of a grid corresponding to the first arrangement;
comparing coordinates of FLSs in the first unit of the grid in the first arrangement with coordinates of the FLSs in the first unit of the grid in the second arrangement;
identifying a subset of the FLSs in the first unit of the grid whose coordinates in the second arrangement do not match their coordinates in the first arrangement, wherein the coordinates of the subset of the FLSs in the first unit of the grid in the second arrangement are within the first unit of the grid; and
determining flight paths for the subset of FLSs in the first unit of the grid.

52. (canceled)

53. (canceled)

54. (canceled)

55. A system comprising:
a first dispatcher configured to dispatch a first set of flying light specks (FLSs);
a second dispatcher configured to dispatch a second set of FLSs;
a controller configured to:
determine an arrangement of FLSs;
transmit a first signal to the first dispatcher to dispatch a first subset of the first set of FLSs to the arrangement; and
transmit a second signal to the second dispatcher to dispatch a second subset of the second set of FLSs to the arrangement.

56. The system of claim 55, wherein the controller is further configured to transmit the first and second signals such that a first portion of the arrangement comprises the first subset and a second portion of the arrangement comprises the second subset, wherein the first portion is nearer to the first dispatcher than the second dispatcher and the second portion is nearer to the second dispatcher than the first dispatcher.

57. The system of claim 56, wherein the controller is further configured to at least one of:
transmit the first and second signals to minimize a flight time of the first subset and the second subset based on the first subset being more visible to a viewer than the second subset,
transmit the first and second signals to minimize a flight distance of the first subset and the second subset, or
minimize a dispatch time of the first subset and the second subset.

58. (canceled)

59. (canceled)

60. The system of claim 55, wherein the controller is further configured to:
identify a dispatch rate for the first dispatcher;
identify a dispatch rate for the second dispatcher; and
determine the first subset and the second subset based on the dispatch rates for the first and second dispatchers.

61. (canceled)

62. (canceled)

63. (canceled)

64. (canceled)
